(19) United States
(12) Patent Application Publication
(10) Pub. No.: US 2024/0114461 A1
(43) Pub. Date: Apr. 4, 2024

(54) PIGGYBACKING ENERGY REQUESTS AND REPORTS ON BSR

(71) Applicant: QUALCOMM Incorporated, San Diego, CA (US)

(72) Inventors: Ahmed ELSHAFIE, San Diego, CA (US); Diana MAAMARI, San Diego, CA (US); Linhai HE, San Diego, CA (US); Huilin XU, Temecula, CA (US); Yuchul KIM, San Diego, CA (US)

(21) Appl. No.: 17/937,738

(22) Filed: Oct. 3, 2022

(51) Int. Cl. H04W 52/02; H04W 28/02

(52) U.S. Cl. CPC H04W 52/0261; H04W 28/0278

(57) ABSTRACT

Apparatuses and methods for piggybacking energy requests and reports on BSRs are described. An apparatus is configured to receive a configuration, for a set of BSRs, including field configuration information for each BSR of the set associated with a LCG. The apparatus is also configured to transmit a BSR for each LCG. The BSR for each LCG of the set includes energy information that is encoded in the BSR based on the field configuration information in the configuration. Another apparatus is configured to transmit a configuration, for a set of BSRs, including field configuration information for each BSR of the set associated with a LCG. The other apparatus is configured to receive a BSR for each LCG. The BSR for each LCG includes energy information that is encoded in the BSR based on the field configuration information in the configuration.

### TECHNICAL FIELD

The present disclosure relates generally to communication systems, and more particularly, to wireless communications utilizing buffer status reports.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to receive, from a network node, a configuration for a set of buffer status reports (BSRs), where the configuration includes field configuration information for each BSR of the set of BSRs associated with a corresponding logical channel group (LCG) in a set of LCGs. The apparatus is also configured to transmit, for the network node, a BSR for each LCG of the set of LCGs, where the BSR for each LCG of the set of LCGs includes energy information, where the energy information is encoded in the BSR based on the field configuration information in the configuration.

In the aspect, the method includes receiving, from a network node, a configuration for a set of buffer status reports (BSRs), where the configuration includes field configuration information for each BSR of the set of BSRs associated with a corresponding logical channel group (LCG) in a set of LCGs. The method also includes transmitting, for the network node, a BSR for each LCG of the set of LCGs, where the BSR for each LCG of the set of LCGs includes energy information, where the energy information is encoded in the BSR based on the field configuration information in the configuration.

In another aspect of the disclosure, a method, a computer-readable medium, and an apparatus are provided for wireless communication at a network node. The apparatus is configured to transmit, for a UE, a configuration for a set of BSRs, where the configuration includes field configuration information for each BSR of the set of BSRs associated with a corresponding LCG in a set of LCGs. The other apparatus is also configured to receive, from the UE, a BSR for each LCG of the set of LCGs, where the BSR for each LCG of the set of LCGs includes energy information, where the energy information is encoded in the BSR based on the field configuration information in the configuration.

In the other aspect, the method includes transmitting, for user equipment (UE), a configuration for a set of buffer status reports (BSRs), where the configuration includes field configuration information for each BSR of the set of BSRs associated with a corresponding logical channel group (LCG) in a set of LCGs. The method also includes receiving, from the UE, a BSR for each LCG of the set of LCGs, where the BSR for each LCG of the set of LCGs includes energy information, where the energy information is encoded in the BSR based on the field configuration information in the configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example buffer status report (BSR), in accordance with various aspects of the present disclosure.

FIG. 5 is a call flow diagram for wireless communications, in accordance with various aspects of the present disclosure.

FIG. 6 is a diagram for example time gaps between consecutive allocations in wireless communications, in accordance with various aspects of the present disclosure.

FIG. 7 is a diagram illustrating an example BSR with energy request/report piggybacking/multiplexing, in accordance with various aspects of the present disclosure.

FIG. 8 is a diagram illustrating an example BSR with energy request/report piggybacking/multiplexing, in accordance with various aspects of the present disclosure.

FIG. 9 is a diagram illustrating an example BSR with energy request/report piggybacking/multiplexing, in accordance with various aspects of the present disclosure.

FIG. 10 is a diagram illustrating an example UE with energy information, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

Various aspects herein relate to piggybacking/multiplexing energy requests and reports on buffer status registers (BSRs). Energy harvesting (EH) and backscatter communications may include support by 3GPP for 5G NR. Internet of Things (IoT) devices, passive IoT devices, low-/zero-power IoT devices, low-/narrow-band IoT devices, self-powered devices, low-/ultra-low-power radios, and/or other low-/no-power devices (e.g., low tier devices, devices utilized for identification (e.g., smart labels, etc.), tracking, sensing (e.g., acceleration, pressure, humidity, light, vibration, gas, positioning, and/or the like), etc.), as well as user equipment (UE(s)) may harvest or passively receive/gather power, in whole or in part, or may be configured low power consumption/expenditure and EH. A BSR is a type of (MAC) control element (MAC-CE), transmitted from a UE to a network entity, which carries information associated with how much data is in the UE buffer to be sent out, e.g., a MAC layer message from the UE to the network entity that indicates the UE has data to transmit via a grant from the network entity (which may be allocated as a minimum amount of resources, e.g., for a PUSCH, if the resource is available). The described aspects provide for the ability to for piggyback/multiplex energy requests/reports on BSRs provide enhanced communications capabilities via uplink BSRs, where a UE is enabled to indicate some energy information (e.g., energy reports and/or energy requests) by piggybacking or multiplexing such energy information in the BSR. This allows the UE and network entities/sideling UEs to communication with the UE in a manner that takes the UE's energy usage/collecting capabilities. As one example, if a UE has data to send, the UE may indicate how much charging rate it has currently so that a gNB can assign resources or TB s, or configure grants or a gap between grants based charging rate accordingly, etc., for communications with the UE

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

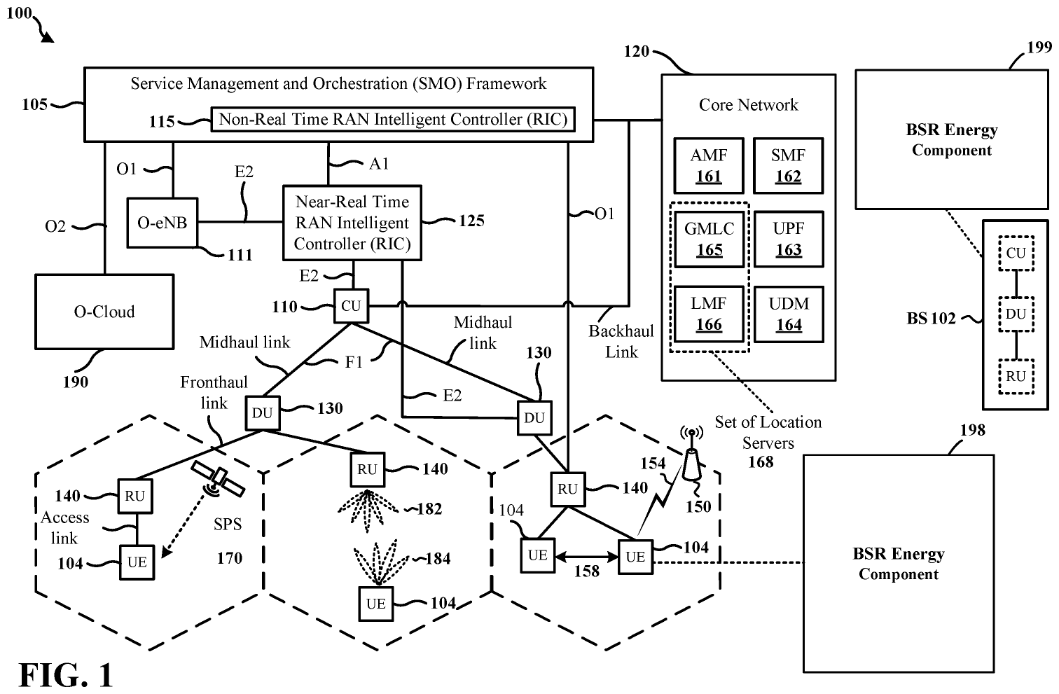

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a BSR energy component 198 (“component 198”) that is configured to receive, from a network node, a configuration for a set of buffer status reports (BSRs), where the configuration includes field configuration information for each BSR of the set of BSRs associated with a corresponding logical channel group (LCG) in a set of LCGs. The BSR energy component 198 is also configured to transmit, for the network node, a BSR for each LCG of the set of LCGs, where the BSR for each LCG of the set of LCGs includes energy information, and where the energy information is encoded in the BSR based on the field configuration information in the configuration. In one aspect, the BSR energy component 198 may also be configured to generate the BSR for each LCG of the set of LCGs to include the energy information encoded in the BSR based on the field configuration information received in the configuration.

In one aspect, where the BSR has a long BSR format or a long truncated BSR format the, BSR energy component 198, to generate the BSR, may also be configured to replace at least one field in the long BSR format or the long truncated BSR format with a short BSR format, the energy information being encoded in place of at least a portion of a LCG identifier (ID) for the BSR, the LCG ID being a number of bits in the short BSR format. In one aspect, the BSR energy component 198 may also be configured to generate the BSR to include second energy information encoded in place of buffer status information for the BSR based on the field configuration information received in the configuration. In one aspect, the BSR energy component 198 may also be configured to transmit, for the network node, an indication of a number of LCGs supported by the UE, where the configuration information and the set of LCGs are based on the indication of the number of LCGs supported by the UE. In one aspect, the BSR energy component 198 may also be configured to generate the BSR, in a long BSR format or a long truncated BSR format, where to generate the BSR in the long BSR format or the long truncated BSR format, the BSR energy component 198 may be configured to reduce a total number of bits for LCG identifiers (IDs) in the BSR to a first set of bits, respectively corresponding to a reduced set of buffer status information fields, a remaining number of bits of the total number of bits including a second set of bits, encode energy field IDs in the second set of bits, and encode second energy information in place of buffer status information in one or more BSR fields corresponding to the second set of bits for the BSR based on the field configuration information received in the configuration.

In certain aspects, the base station 102 may include a BSR energy component 199 (“component 199”) that is configured to transmit, for a UE, a configuration for a set of buffer status reports (BSRs), where the configuration includes field configuration information for each BSR of the set of BSRs associated with a corresponding logical channel group (LCG) in a set of LCGs. The BSR energy component 199 is also configured to receive, from the UE, a BSR for each LCG of the set of LCGs, where the BSR for each LCG of the set of LCGs includes energy information, and where the energy information is encoded in the BSR based on the field configuration information in the configuration. In one aspect, the BSR energy component 199 may also be configured to generate the configuration, where the field configuration information in the configuration indicates at least one of: the BSR to encode the energy information being a lowest priority BSR in the corresponding LCG of the set of LCGs, a plurality of BSRs, corresponding to respective LCG identifiers (IDs), to encode the energy information in the corresponding LCG based on a maximum limit for a number of LCG IDs of each LCG the set of LCGs, and/or a dedicated LCG ID associated with the energy information. In one aspect, the BSR energy component 199 may also be configured to receive, from the UE, an indication of a number of LCGs supported by the UE, where the configuration information and the set of LCGs are based on the indication of the number of LCGs supported by the UE. Although the following description may be focused on 5G NR, the concepts described herein may be applicable to other similar areas, such as LTE, LTE-A, CDMA, GSM, and other wireless technologies.

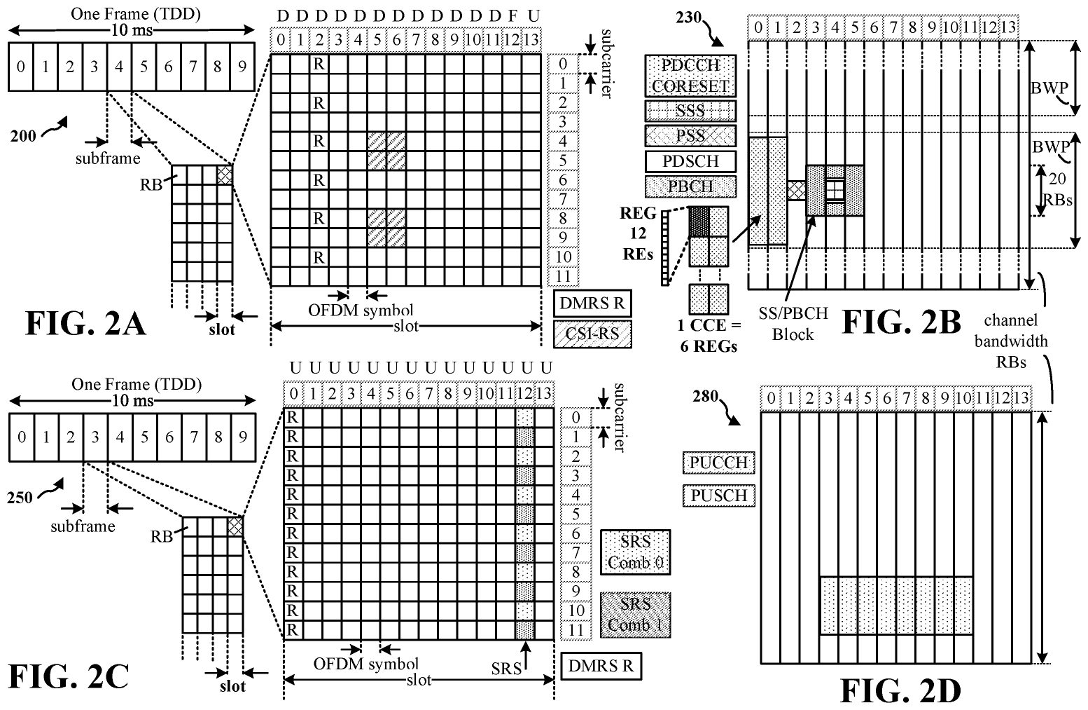

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology ii, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology 1.1=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

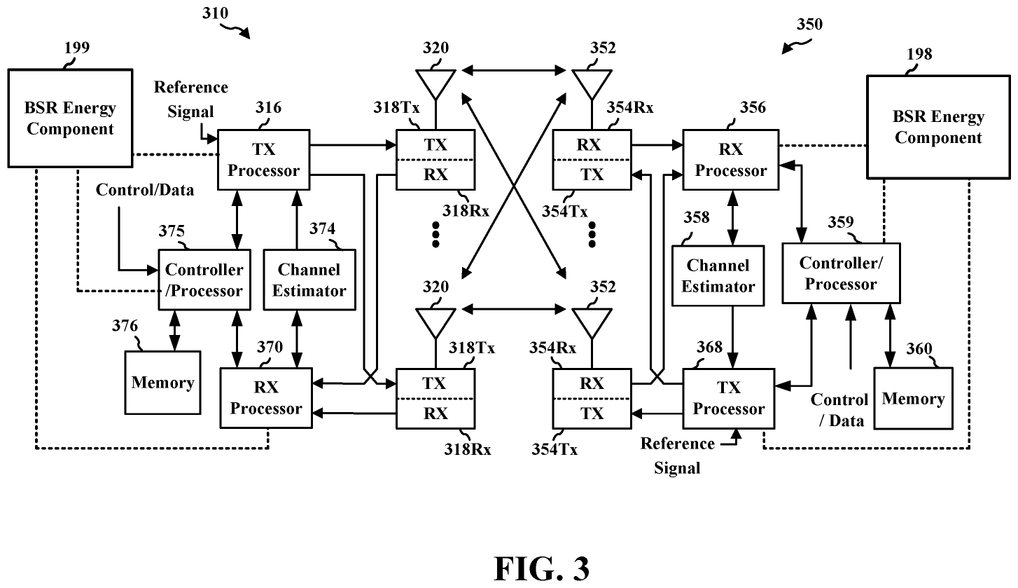

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the BSR energy component 198 of FIG. 1. At least one of the TX processor 316, the RX processor 370, and the controller/processor 375 may be configured to perform aspects in connection with the BSR energy component 199 of FIG. 1.

Energy harvesting (EH) and backscatter communications may include support by 3GPP for 5G NR. IoT devices, passive IoT devices, low-/zero-power IoT devices, low-/narrow-band IoT devices, self-powered devices, low-/ultra-low-power radios, and/or other low-/no-power devices (e.g., low tier devices, devices utilized for identification (e.g., smart labels, etc.), tracking, sensing (e.g., acceleration, pressure, humidity, light, vibration, gas, positioning, and/or the like), etc.) may harvest or passively receive/gather power, in whole or in part. Additionally, these devices may be UEs for aspects herein. For example, solar, indoor solar, thermal, wind, capacitive batteries, printed batteries, etc., may offer sufficient, but limited, power to operate such devices. Lower and/or alternative power capabilities for such devices leads to limitations on communications therefor, which may utilize connectivity to a gateway for further transmission via the Internet and/or to the cloud for reporting information, status, for providing software as a service (SaaS) working with EH sensors, for cloud offerings for data processing services, etc. Additionally, lower and/or alternative power operations may lead to underutilization of resources used for reporting of buffer status of devices, e.g., in various types of UEs including, without limitation, examples of the UEs 104 described with respect to FIG. 1.

Aspects may pertain to legacy and/or new communication protocols/standards, e.g., EH enabled communication services (EHECS) in 5G System. The aspects may be applicable to battery-less or limited energy storage (e.g., capacitor) devices, as noted above, and may include power sourcing or RF or others mechanisms, security, access control/connectivity management, positioning, etc. Aspects may also be applied to IoT devices for 5G-Advanced, service conditions, key performance indicators (KPI) (e.g., data rate, power, densities, etc.), different models (e.g., public land mobile networks (PLMN), non-public networks (NPN), etc.), on-boarding and provisioning, decommissioning of devices, etc., identification, authentication/authorization, access control, mobility management, security, and conditions for communication, etc.

Aspects herein for piggybacking/multiplexing energy requests and reports on BSRs provide enhanced communications capabilities. For instance, including energy information (e.g., for energy requests and/or reports) in the BSR for such information sharing with the network may reduce the number of transmissions required by the UE. As an example, if a UE has data to send to a gNB, the UE may indicate how much charging rate it has currently, by providing this information as multiplexed/piggybacked in a BSR, so that a gNB can assign resources or TB s, or configure grants accordingly, or a gap between grants based charging rate, and/or the like. Aspects herein include details about energy requests and energy reports being provided as multiplexed/piggybacked via BSR. These aspects improve the utilization of power-consuming resources for reception/transmission by allowing the UE to send energy information at the same time buffer status information is sent (and in the same data footprint without additional transmissions), and also allow a UE to dynamically indicate times between transmissions such that the UE has a minimum gap in which to accumulate more power for reception/transmission. For example, a UE may receive, from a network node, a configuration for a set of BSRs, where the configuration includes field configuration information for one or more fields in each BSR of the set of BSRs associated with a corresponding LCG in a set of LCGs, and the UE may transmit, for the network node, a BSR for each LCG of the set of LCGs, where the BSR for each LCG of the set of LCGs includes energy information, and where the energy information is encoded in the BSR based on the field configuration information in the configuration. A logical channel group, i.e., LCG, may be a may be, for example, a group of logical channels for which buffer status is being reported. Accordingly, aspects may provide enhancements for BSRs to support energy requests and reports piggybacking/multiplexing.

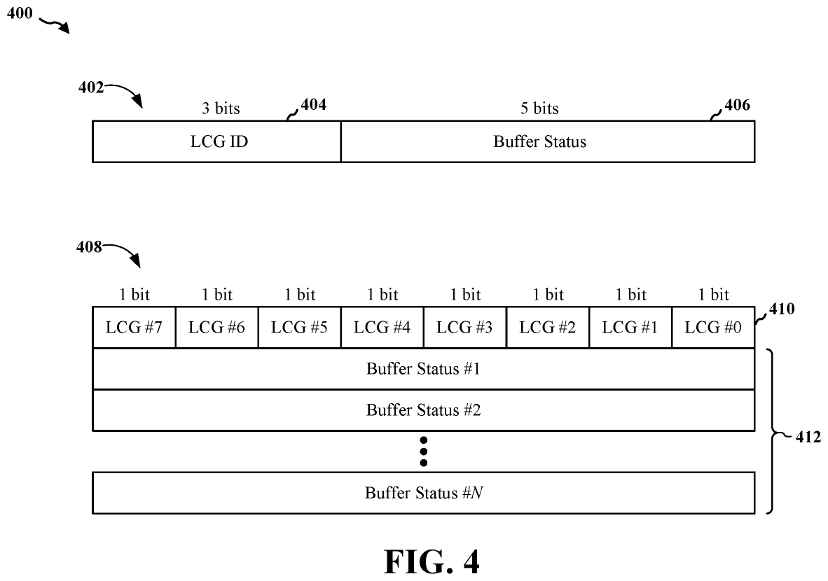

FIG. 4 is a diagram 400 illustrating an example buffer status report (BSR), in various aspects. Diagram 400 includes a configuration 402 and a configuration 408, by way of example. Configuration 402 shows an example structure of a short BSR configuration and/or a short truncated BSR configuration. Configuration 408 shows an example structure of a long BSR configuration and/or a long truncated BSR configuration. In aspects, a short BSR configuration and/or a short truncated BSR configuration, as illustrated for configuration 402, and/or a long BSR configuration and/or a long truncated BSR configuration, as illustrated for configuration 408, may each be transmitted in a MAC-CE.

A logical channel may be used to provide various types of data transfer services via the MAC layer to the RLC layer in wireless communications, e.g., in 5G NR, and may be characterized by the type of information/data carried. An LCG may be a group of logical channels in which buffer status is being reported. As one example, when there are four LCGs being used, each LCG of the group may have its own ID from 0 to 3, or when there are eight LCGs being used, each LCG of the group may have its own ID from 0 to 7.

Configuration 402 shows an example structure of a short BSR configuration and/or a short truncated BSR configuration. As shown for configuration 402, a short BSR configuration and/or a short truncated BSR configuration may include 8 bits of data. Of the 8 bits, 3 bits may be used for an LCG ID 404 of the LCG and 5 bits may be used for a BSR 406. The structure and size of a short BSR configuration and a short truncated BSR configuration may be the same. In aspects, differences between a short BSR configuration and a short truncated BSR configuration may include, without limitation, that the short BSR configuration may provide information when a single LCG has data to transfer, whereas the short truncated BSR configuration may provide information regarding the particular LCG that includes a highest priority logical channel, e.g., when multiple LCGs have data to transfer.

Configuration 408 shows an example structure of a long BSR configuration and/or a long truncated BSR configuration. As shown for configuration 402, the structure of a long BSR configuration and/or a long truncated BSR configuration, these MAC-CE structures may have the same format but with a variable size. For example, configuration 408 shows a first byte (i.e., 8 bits) that represents LCG IDs 410 for the long BSR configuration and/or the long truncated BSR configuration, while the remaining structure/part represents BSRs 412 (e.g., shown as BSR 0 to BSR N, where N is 7 in the illustrated example) corresponding to the respective bits of the LCG ID 410. The long BSR configuration and the long truncated BSR configuration illustrated may use 8 bits to allow for 2⁸, or 256, indexes which can accommodate a larger buffer status of 81,338,368 bytes.

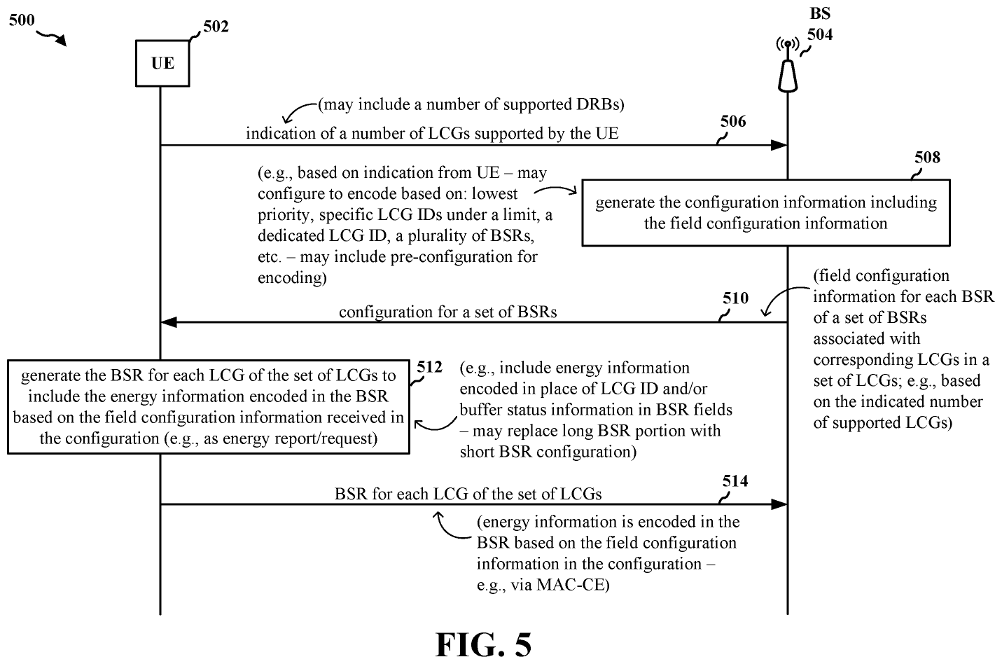

FIG. 5 is a call flow diagram 500 for wireless communications, in various aspects. Call flow diagram 500 illustrates piggybacking/multiplexing energy requests and reports on BSRs.

In the illustrated aspect, a UE 502 may transmit, to a network node (e.g., a gNB 504 or one or more components of a gNB) (also “gNB 504” herein), an indication 506 of a number of LCGs supported by the UE 502. The indication 506 may also include a number of data radio bearers (DRBs) supported by the UE 502, in aspects. The gNB 504 may generate (at 508) configuration information for a configuration 510, for a set of BSRs, which may include field configuration information for formatting a field(s) in a BSR(s) at the UE 502 to piggyback/multiplex energy information therein (e.g., a size in bits of a field, a number of fields utilized, etc.).

The configuration 510 and associated information/field configuration information may be generated (at 508) based on the indication 506 from the UE 502, and may be generated to configure the UE 502 to encode energy information in the BSR(s) based on a priority of the BSR/associated LCG (e.g., a lowest priority(ies), in some aspects a highest priority(ies), a combination thereof, etc.), a specific LCG ID(s), a number of BSRs, etc. The configuration 510 may be generated (at 508) to include a pre-configuration for encoding the energy information. A pre-configuration may be a configuration for piggyback/multiplex energy information in a BSR that is pre-defined or agreed upon initially between a UE and a network node. The information/field configuration information in the configuration 510 for the set of BSRs may be for each BSR in a set of BSRs associated with corresponding LCGs in a set of LCGs. For instance, based on the indicated number of supported LCGs in the indication 506 from the UE 502, the gNB 504 may generate (at 508) the information/field configuration information in the configuration 510 for one or more BSRs of the indicated LCGs.

The configuration 510 may be transmitted by the gNB 504 and received by the UE 502. The UE 502 may then generate (at 512) the BSR for each LCG of the set of LCGs to include the energy information, as encoded in the BSR, e.g., based on the field configuration information received in the configuration 510 for the set of BSRs. The energy information may be information for an energy report and/or an energy request, in aspects, and may include energy information encoded in place of an LCG ID in a BSR and/or buffer status information in BSR status fields. In aspects, to generate the BSRs, the UE 502 may replace (at 512) a portion of a long/long truncated BSR with a short/short truncated BSR configuration.

Subsequent to generation (at 512) by the UE 502, generated BSR(s) 514 for each LCG of the set of LCGs described above may be transmitted to the gNB 504. In aspects, the BSR(s) may include the energy information (e.g., for reporting/requesting) as encoded in the BSR based on the configuration 510 (e.g., the field configuration information therein), and may be transmitted from the UE 502 to the gNB 504 via MAC-CE.

The UE 502 and the gNB may then be configured to communicate based on the energy information encoded in the BSR 514, in aspects. In addition, call flow diagram 500 may continue by repeating one or more portions shown after the BSR 514 is transmitted by the UE 502 to the gNB 504.

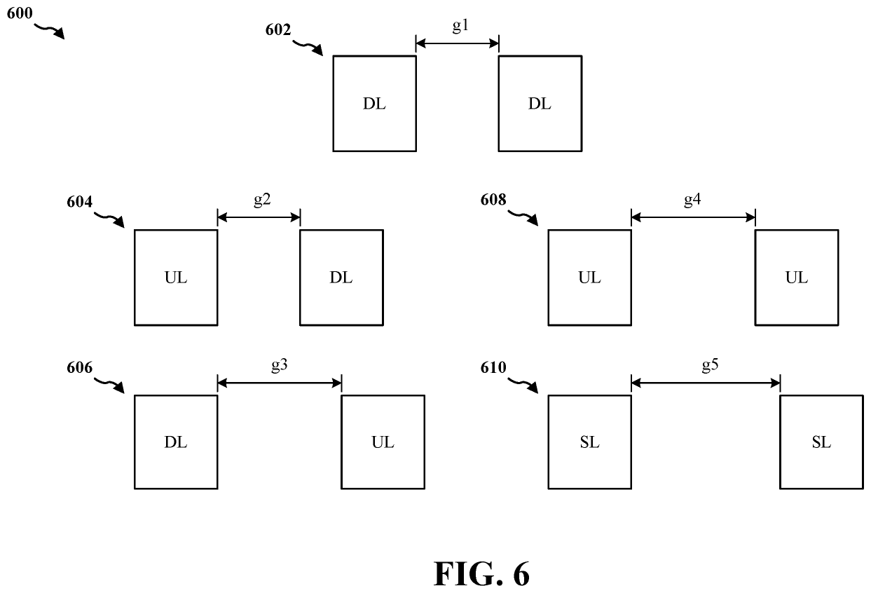

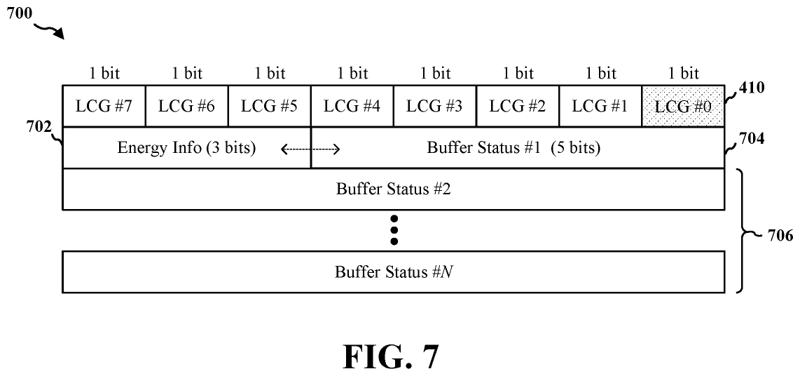

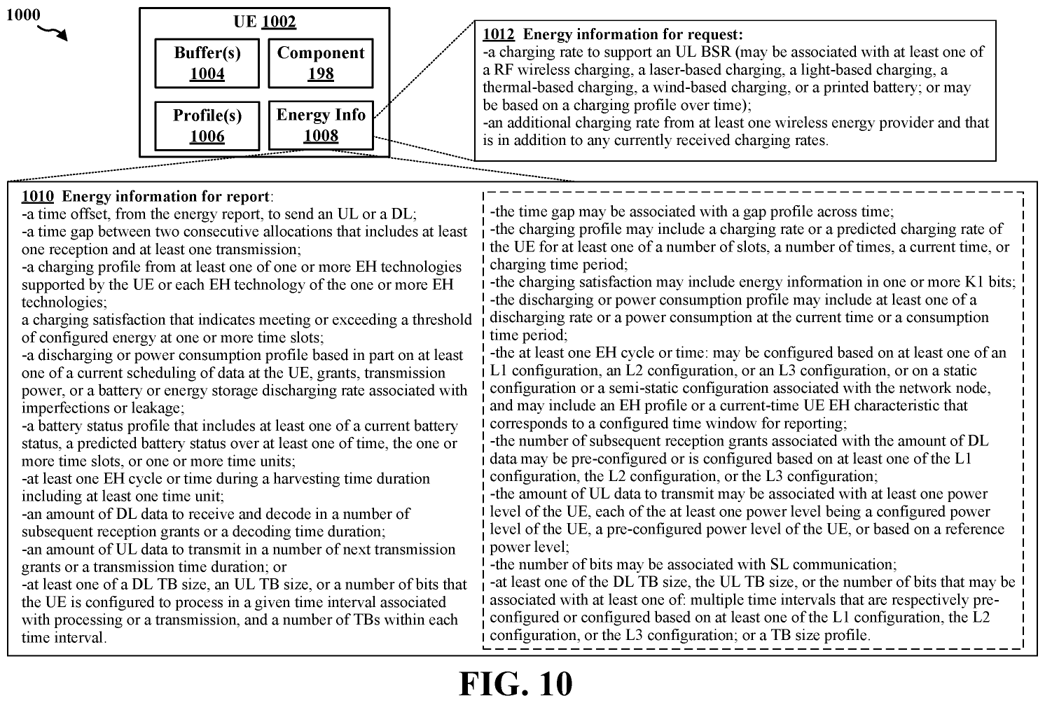

Further details regarding generation (at 512) via implementation of the configuration 510 by the UE 502 for BSRs (e.g., with respect to FIGS. 7, 8, and 9), as well as energy information (e.g., with respect to FIGS. 6 and 10), are provided in the corresponding descriptions below.

FIG. 6 is a diagram 600 for example time gaps between consecutive allocations in wireless communications, in various aspects. For example, as noted above, the described aspects improve the utilization of power-consuming resources for reception/transmission, and also allow a UE to dynamically indicate times between transmissions such that the UE has a minimum gap in which to accumulate more power for reception/transmission.

Diagram 600 illustrates a consecutive allocation 602, a consecutive allocation 604, a consecutive allocation 606, a consecutive allocation 608, and a consecutive allocation 610. Consecutive allocation 602 shows a consecutive allocation between a DL allocation and a DL allocation having a minimum gap g1 there between. Consecutive allocation 604 shows a consecutive allocation between an UL allocation and a DL allocation having a minimum gap g2 there between. Consecutive allocation 606 shows a consecutive allocation between a DL allocation and an UL allocation having a minimum gap g3 there between. Consecutive allocation 608 shows a consecutive allocation between an UL allocation and an UL allocation having a minimum gap g4 there between. Consecutive allocation 610 shows a consecutive allocation between a sidelink (SL) allocation and a SL allocation having a minimum gap g5 there between. The minimum gaps g1, g2, g3, g4, and/or g5 may be of different times/durations from one consecutive allocation to another, and may be different times/durations with respect to each other.

The minimum gaps g1, g2, g3, g4, and/or g5 are illustrative of example minimum gaps that may be needed by a UE in which to accumulate more power for the next (e.g., consecutive) reception/transmission from another UE, a gNB, and/or the like. That is, a UE may report its energy information to another UE, a gNB, and/or the like, in order to enable configuration by the other UE/gNB of configured grant and SPS periodicities that allow the UE to accumulate enough power to perform communication operations. Likewise, a UE may request energy specifications from another UE, a gNB, and/or the like, in order to determine an amount of energy for desired communications with the other UEs/gNBs, and may be configured to report its energy information for configured gaps to meet the energy specified. In aspects, when the UE's energy capacity and/or accumulation does not meet the amount indicated in response to an energy request, the UE may report its own energy information for alternative configurations, as noted above. In aspects, the time separation or gap described above may also be a function of the type of channel and/or transmission associated with a given consecutive allocation (e.g., SRS, CSI-RS, PDSCH, PUSCH, PUCCH, PSSCH, SSB, etc.).

FIG. 7 is a diagram 700 illustrating an example BSR with energy request/report piggybacking/multiplexing, in various aspects, and may be an aspect of diagram 400 in FIG. 4.

For instance, diagram 700 shows an example of replacing a portion of a long BSR configuration (e.g., configuration 408 in FIG. 4) of a given LCG ID (e.g., LCG ID 0, or bit [0] of LCG IDs 410, in diagrams 400, 700) for a buffer status field with a short BSR configuration (as illustrated for configuration 402 in FIG. 4). In diagram 700, the first buffer status (#1) of the BSRs 412 (for a long BSR configuration corresponding to LCG ID 0) is replaced with a short BSR configuration that includes 3 bits for the LCG ID (e.g., as shown for LCG ID 404 in FIG. 4) of the LCG and 5 bits for the BSR (as shown for the BSR 406 in FIG. 4). This results in BSRs 706, where N is 7 in the illustrated example, which have one less BSR than BSRs 412 in FIG. 4. Additionally, instead of the 3 bits for the LCG ID (e.g., as shown for LCG ID 404 in FIG. 4) of the LCG, diagram 700 shows that energy information 702 has been encoded in place thereof, while the remaining 5 bits for the short BSR confirmation are used for a BSR 704 instead of the usual 8 bits in a long BSR configuration (e.g., as shown for the BSRs 706). In aspects, the energy information 702 may be an energy report and/or an energy request. In some aspects, more or fewer than 3 bits may be used in the configuration illustrated in diagram 700.

In addition, the buffer status field corresponding to LCG ID 0 in diagram 700 may be selected for replacement with a short BSR confirmation and energy information encoding based on one more factors as described above for call flow diagram 500 in FIG. 5, such as but not limited to, priority. As described herein, a configuration (e.g., configuration 510 in FIG. 5) may be received by a UE for reporting/requesting energy information. The configuration may include a pre-configuration associated with encoding each of the set of BSRs, where the energy information is encoded based on the pre-configuration.

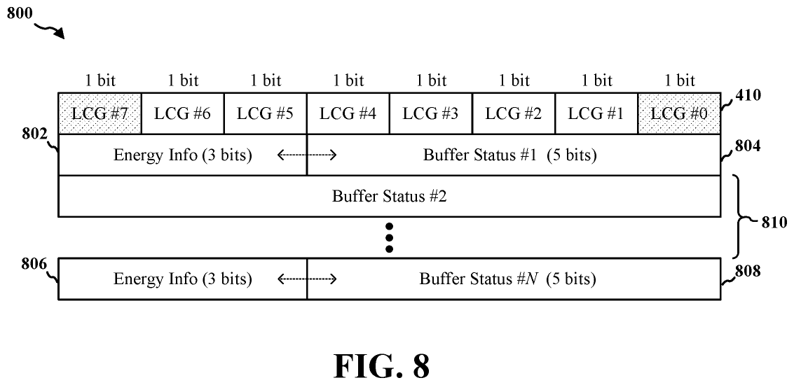

FIG. 8 is a diagram 800 illustrating an example BSR with energy request/report piggybacking/multiplexing, in various aspects, and may be an aspect of diagram 400 in FIG. 4 and/or diagram 700 in FIG. 7.

For instance, diagram 800 shows an example of replacing a portion of a long BSR configuration (e.g., configuration 408 in FIG. 4) of given LCG IDs (e.g., LCG ID 0, (bit [0]) and LCG ID 7 (bit [7]) of LCG IDs 410, in diagrams 400, 700, 800) for buffer status fields with short BSR configurations (as illustrated for configuration 402 in FIG. 4). In diagram 800, the first buffer status (#1) of the BSRs 412 (for a long BSR configuration corresponding to LCG ID 0) and the seventh/last buffer status (#/V) of the BSRs 412 (for a long BSR configuration corresponding to LCG ID 7) are replaced with a short BSR configurations that include 3 bits for the LCG ID (e.g., as shown for LCG ID 404 in FIG. 4) of the LCG and 5 bits for the BSR (as shown for the BSR 406 in FIG. 4). This results in BSRs 810, where N is 7 in the illustrated example, which have two less BSR than BSRs 412 in FIG. 4. Additionally, instead of the 3 bits for the LCG ID 0 and the LCG ID 7 (e.g., as shown for LCG ID 404 in FIG. 4) of the LCG, diagram 800 shows that energy information 802 and energy information 806 have been encoded in place thereof for the short LCG configuration, while the remaining 5 bits for the short BSR confirmation are used for a BSR 804 and a BSR 808 instead of the usual 8 bits in a long BSR configuration (e.g., as shown for the BSRs 810). This enables a UE to utilize 6 bits for energy reporting in the BSR of diagram 800. In aspects, the energy information 802 and/or the energy information 806 may be an energy report and/or an energy request. In some aspects, more or fewer than 6 bits may be used in the configuration illustrated in diagram 800.

In addition, the buffer status fields corresponding to LCG ID 0 and/or LCG ID N in diagram 800 may be selected for replacement with a short BSR confirmation and energy information encoding based on one more factors as described above for call flow diagram 500 in FIG. 5, such as but not limited to, priority. As described herein, a configuration (e.g., configuration 510 in FIG. 5) may be received by a UE for reporting/requesting energy information. The configuration may include a pre-configuration associated with encoding each of the set of BSRs, where the energy information is encoded based on the pre-configuration.

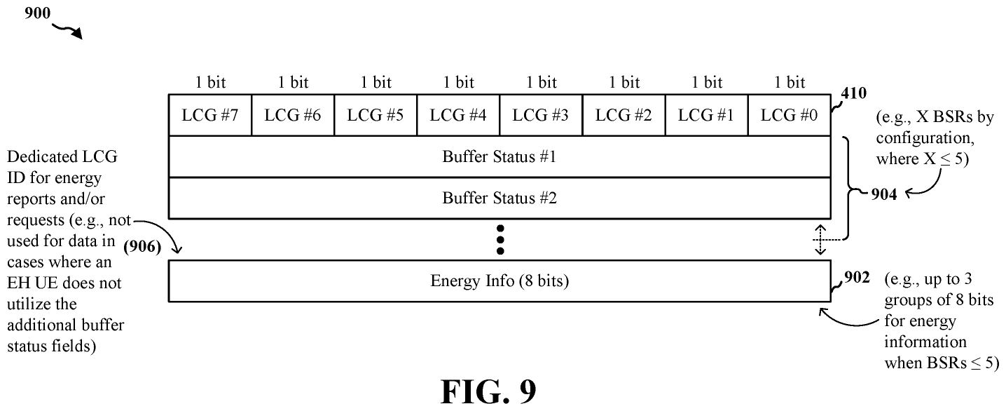

As described above for FIGS. 7 and 8, different numbers of bits may be configured for reporting and requesting of energy information in BSR, according to the examples described for various aspects. Diagram 700 illustrates that 3 bits are encoded with energy information, thus truncating 3 bits from a status report field of the BSRs. Similarly, diagram 800 illustrates that 6 bits are encoded with energy information, thus truncating 3 bits from each of two status report fields of the BSRs for a total of 6 bits for energy information. Aspects herein, however, are not so limited, and include truncating more, or fewer, of the bits for status report fields of the BSRs to transmit energy information. In some aspects, a determination may be made for configurations that specify the number of bits to be truncated based on relative priority of a given LCG, the content of the energy request/report, etc. As an illustrative example, referring to FIG. 8 and diagram 800, aspects contemplate the energy information 802 as including 2 bits and energy information 806 including 4 bits, based on the LCG corresponding to LCG ID 7 having a lower priority relative to the LCG corresponding to LCG ID 0, or vice versa. In this context, FIG. 9 will now be described.

In addition, a network entity such as a gNB may indicate to a UE via a configuration that the UE add more bits to energy information transmission or to a BSR of a certain LCG ID. Such configuration may be based on energy information (in cases of either an energy report or an energy request), and in some aspects may be based on how many bits are specified for the request/report and respective contents. In some aspects, by indication from gNB via a configuration, the lowest one or more of low prior LCG BSRs may be entirely used for energy information reporting/requesting. For example, the UE may be configured to fully drop the contents of a certain BSR of a certain LCG ID based on priority, RRC/MAC-CE, gNB configuration, etc.).

FIG. 9 is a diagram 900 illustrating an example BSR with energy request/report piggybacking/multiplexing, in various aspects. Diagram 900 may show multiple alternative aspects to those described above for FIGS. 4, 7, and 8.

As one example, diagram 900 includes a long BSR configuration as shown in configuration 408 of FIG. 4, where BSRs 412 of configuration 408 are replaced by a fewer number of BSRs shown as BSRs 904. The fewer number of BSRs in BSRs 904 may be based on a limited number of true BSRs for a UE to report buffer status. That is, the BSRs in this alternative aspect are limited, e.g., via configuration by a gNB, to a maximum number of LCGs, e.g., X≤5. In this example, the remaining LCG IDs may then be utilized for energy information reporting and/or requesting. That is, a EH UE (e.g., an energy harvesting UE or device) may not utilize the full 16 DRBs or the 8 LCGs available as eMBB UEs do. For instance, an EH UE may utilize 5 (or less) LCGs in some scenarios. In such cases, as illustrated for diagram 900, one or more of the unused LCGs may be used entirely for energy information reporting/requesting in the BSR shown in diagram 900 by energy information 902 (8 bits). It is further contemplated that aspects described include additional sets of 8 bits for the energy information 902, e.g., two additional sets of 8 bits where BSRs 904 are limited to 5 via configuration.

As another example, the number of supported LCGs or DRBs or a UE may be dynamically configured or indicated by the UE, and agreed upon with the network (e.g., the gNB). In such configurations, the UE may indicate over time how many and which DRBs/LCGs the UE supports, so the number (‘X’) of utilized DRBs/LCGs may change over time based, at least in part, on energy availability/accumulation capability and/or energy status of the UE. In the context of the prior example above, over time, the UE may determine that ‘X’ should be reduced from 5 to 4, and thus BSRs 904 may include 4 BSRs, while energy information 902 may now include 4 sets of 8 bits for energy reporting/requesting.

In an additional example, one or more new, dedicated LCG IDs may be implemented. These new, dedicated LCG IDs may be used as a new logical channel ID 906 for a new combined buffer and energy information configuration for energy requests/reports, such as for when an EH UE does utilize the additional buffer status fields (e.g., as represented by diagram 900 with the new logical channel ID 906 implemented.

FIG. 10 is a diagram 1000 illustrating an example UE 1002 and energy information 1008, in various aspects. In diagram 1000, the UE 1002 is shown as including a buffer 1004 and component 198.

The buffer 1004 may be a part of a memory or storage, as described herein, and may be the buffer for which reports (e.g., BSRs) are performed with the energy information 1008 piggybacked/multiplexed in the BSRs. Component 198 may be configured to perform associated aspects described for piggybacking/multiplexing the energy information 1008 in the BSRs, as described in further detail herein. Also illustrated in diagram 1000 is a profile(s) 1006, which may be one or more profiles that are utilized by UE 1002 and component 198 in reporting the energy information 1008. Energy information, generally, may be information associated with energy capabilities/status of a UE and/or energy specified by a network/network entity for communications. The profile(s) 1006 may be static profiles or dynamic profiles (e.g., profiles determined over time), in aspects.

The energy information 1008 may include an energy information portion 1010 for energy reports and an energy information portion 1012 for energy requests. For example, in aspects, the energy information 1008 used for reporting (the energy information portion 1010) may include at least one of a time offset, from the energy report, to send an UL or a DL; a time gap between two consecutive allocations that includes at least one reception and at least one transmission; a charging profile from at least one of one or more EH technologies supported by the UE or each EH technology of the one or more EH technologies; a charging satisfaction that indicates meeting or exceeding a threshold of configured energy at one or more time slots; a discharging or power consumption profile (e.g., where predicted charging is in one or more slots/times) based in part on at least one of a current scheduling of data at the UE, grants, transmission power, or a battery or energy storage discharging rate associated with imperfections or leakage; a battery status profile that includes at least one of a current battery status, a predicted battery status over at least one of time, the one or more time slots, or one or more time units; at least one EH cycle or time during a harvesting time duration including at least one time unit; an amount of DL data to receive and decode in a number of subsequent reception grants or a decoding time duration; an amount of UL data to transmit in a number of next transmission grants or a transmission time duration; or at least one of a DL TB size, an UL TB size, or a number of bits that the UE is configured to process in a given time interval associated with processing or a transmission, and a number of TB s within each time interval.

Regarding EH cycles/times, it should be noted that due to some hardware constraints that may apply, some EH UEs (e.g., those that use RF EH with time-switching EH), such UEs cannot receive data and harvest at same time. In addition, for general cases where a device cannot handle data and EH (regardless of type) at same time, the EH cycle has to be known so that data versus EH conflicts can be resolved, and also so that the network/network entity (e.g., gNB) or a SL-UE can avoid scheduling DL/transmissions to UE at those times.

For the energy information portion 1010 of the energy information 1008 associated with reporting, in aspects, the time gap may be associated with a gap profile across time; the charging profile may include a charging rate or a predicted charging rate of the UE for at least one of a number of slots, a number of times, a current time, or charging time period; the charging satisfaction may include energy information in one or more K1 bits; the discharging or power consumption profile may include at least one of a discharging rate or a power consumption at the current time or a consumption time period; the at least one EH cycle or the time during the harvesting time duration: may be configured based on at least one of a layer 1 (L1) configuration, a layer 2 (L2) configuration, or a layer 3 (L3) configuration, or on a static configuration or a semi-static configuration associated with the network node, and may include an EH profile or a current-time UE EH characteristic that corresponds to a configured time window for reporting; the number of next reception grants associated with the amount of DL data may be pre-configured or is configured based on at least one of the L1 configuration, the L2 configuration, or the L3 configuration; the amount of UL data to transmit may be associated with at least one power level of the UE, each of the at least one power level being a configured power level of the UE, a pre-configured power level of the UE, or based on a reference power level; the number of bits may be associated with SL communication; and/or at least one of the DL TB size, the UL TB size, or the number of bits that may be associated with at least one of: multiple time intervals that are respectively pre-configured or configured based on at least one of the L1 configuration, the L2 configuration, or the L3 configuration; or a TB size profile (a desired DL TB size or UL TBS or number of bits (in a certain duration or within a transmission; UL or DL or SL) that the UE can process and a number of TB s within each time interval, where this can also be across time; from t1 to t2, from t2 to t3, etc. (e.g., t1, t2, t3, etc., are all agreed and pre-configured or configured via L1/L2/L3), or as a profile, e.g., as part of profile(s) 1006).

In aspects, the energy information 1008 used for reporting (the energy information portion 1012) may include a charging rate that is specified to support an UL BSR (which may be associated with at least one of a RF wireless charging, a laser-based charging, a light-based charging, a thermal-based charging, a wind-based charging, or a printed battery; or may be based on a charging profile over time) and/or an additional charging rate that is specified from at least one wireless energy provider and that is in addition to any currently received charging rates.

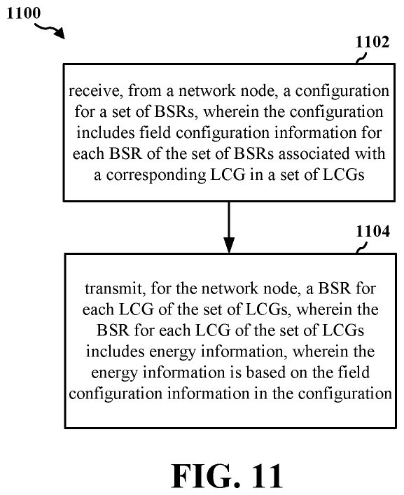

FIG. 11 is a flowchart 1100 of a method of wireless communication, in various aspects. The method may be performed by a UE (e.g., the UE 104, 502, 1002; the apparatus 1504). At 1102, the UE receives, from a network node, a configuration for a set of buffer status reports (BSRs), where the configuration includes field configuration information for each BSR of the set of BSRs associated with a corresponding logical channel group (LCG) in a set of LCGs. In some aspects, 1102 may be performed by the component 198. At 1104, the UE transmits, for the network node, a BSR for each LCG of the set of LCGs, where the BSR for each LCG of the set of LCGs includes energy information, where the energy information is encoded in the BSR based on the field configuration information in the configuration. In some aspects, 1104 may be performed by the component 198.

For example, referring to FIG. 5, the UE 502 may receive the configuration 510 for a set of BSRs from the gNB 508. The configuration 510 and associated information/field configuration information therein may be generated (at 508) by the gNB 504 based on the indication 506 from the UE 502, and may be generated to configure the UE 502 to encode energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) in the BSR(s) (diagram 700 as shown in FIG. 7; diagram 800 as shown in FIG. 8; diagram 900 as shown in FIG. 9) based on a priority of the BSR/associated LCG (e.g., a lowest priority(ies)), a specific LCG ID(s), a number of BSRs, etc., and may include a pre-configuration (e.g., 510 as shown in FIG. 5) for encoding the energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10). The information/field configuration information in the configuration 510 for the set of BSRs may be for each BSR in a set of BSRs associated with corresponding LCGs in a set of LCGs (e.g., LCG ID 0 as shown in FIG. 7; LCG ID 0, LCG ID 7 as shown in FIG. 8; LCG ID 7, LCG IDs 5-7 as shown in FIG. 9). The configuration 510 may be transmitted by the gNB 504 and received by the UE 502. The UE 502 may then transmit the generated BSR(s) 514 (diagram 700 as shown in FIG. 7; diagram 800 as shown in FIG. 8; diagram 900 as shown in FIG. 9) for each LCG of the set of LCGs (e.g., LCG ID 0 as shown in FIG. 7; LCG ID 0, LCG ID 7 as shown in FIG. 8; LCG ID 7, LCG IDs 5-7 as shown in FIG. 9) to the gNB 504. In aspects, the BSR(s) may include the energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) (for reporting/requesting) as encoded in the BSR (e.g., LCG ID 0 as shown in FIG. 7; LCG ID 0, LCG ID 7 as shown in FIG. 8; LCG ID 7, LCG IDs 5-7 as shown in FIG. 9) based on the configuration 510 (e.g., the field configuration information therein), and may be transmitted from the UE 502 to the gNB 504 via MAC-CE.

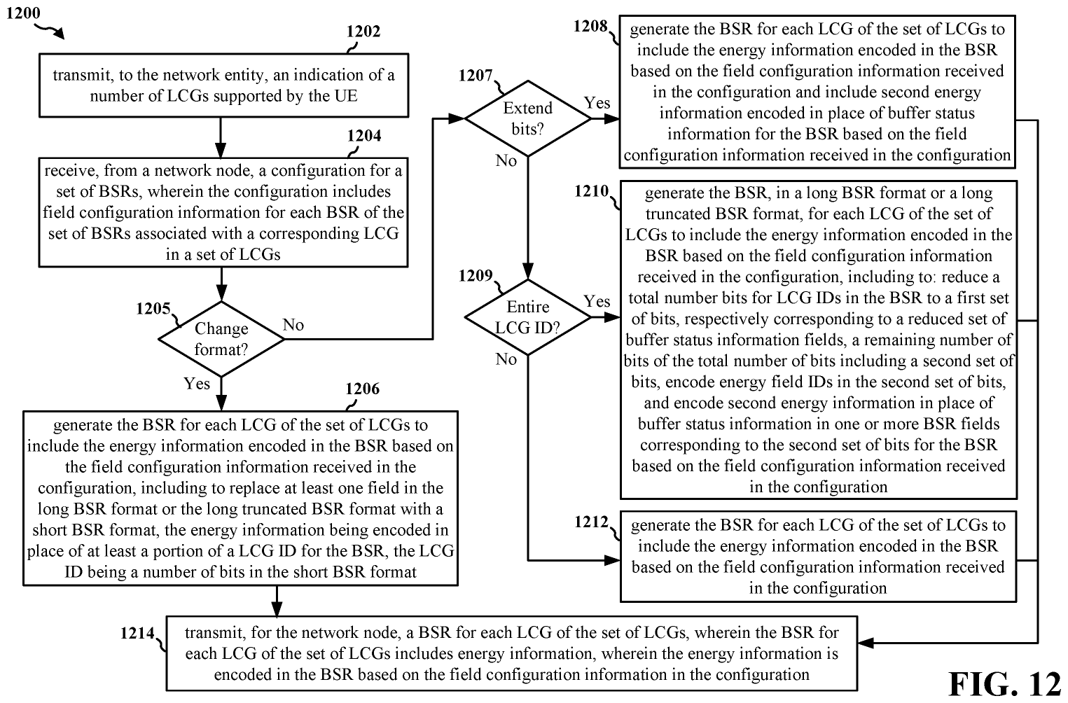

FIG. 12 is a flowchart 1200 of a method of wireless communication in various aspects. The method may be performed by a UE (e.g., the UE 104, 502, 1002; the apparatus 1504). At 1202, the UE may transmit, to a network node, an indication of a number of LCGs supported by the UE. In some aspects, 1202 may be performed by the component 198. For example, referring to FIG. 5, the UE 502 may transmit to the gNB 504 (or one or more components of the gNB 504) the indication 506 of a number of LCGs supported (e.g., LCG ID 0 as shown in FIG. 7; LCG ID 0, LCG ID 7 as shown in FIG. 8; LCG ID 7, LCG IDs 5-7 as shown in FIG. 9) by the UE 502. The indication 506 may also include a number of data radio bearers (DRBs) supported by the UE 502, in aspects.

At 1204, the UE may receive, from the network entity, a configuration for a set of buffer status reports (BSRs), where the configuration includes field configuration information for each BSR of the set of BSRs associated with a corresponding logical channel group (LCG) in a set of LCGs. In some aspects, 1204 may be performed by the component 198. For example, referring again to FIG. 5, the UE 502 may receive the configuration 510 for a set of BSRs that is transmitted by the gNB 508. The configuration 510 and associated information/field configuration information therein may be generated (at 508) by the gNB 504 based on the indication 506 from the UE 502, and may be generated to configure the UE 502 to encode energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) in the BSR(s) (e.g., diagram 700 as shown in FIG. 7; diagram 800 as shown in FIG. 8; diagram 900 as shown in FIG. 9) based on a priority of the BSR/associated LCG (e.g., a lowest priority(ies)), a specific LCG ID(s), a number of BSRs, etc., and may include a pre-configuration (e.g., 510 as shown in FIG. 5) for encoding the energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10). The information/field configuration information in the configuration 510 for the set of BSRs may be for each BSR in a set of BSRs associated with corresponding LCGs in a set of LCGs (e.g., LCG ID 0 in FIG. 7; LCG ID 0, LCG ID 7 as shown in FIG. 8; LCG ID 7, LCG IDs 5-7 as shown in FIG. 9).

At 1205, it is determined of the configuration received by the UE from the network node configures the UE to change the format of its BSR. In some aspects, 1204 may be performed by the component 198. For example, referring again to FIG. 5, the configuration 510 received by the UE 502 from the gNB 504 may configure the UE 502 to change from a short BSR format to long BSR format, to change a portion of a long BSR format to be in the configuration of a short BSR format (e.g., 702/704 as shown in FIG. 7; 802/804, 806/808 as shown in FIG. 8), etc. If it is determined at 1205 that this format change is configured (Yes), flowchart 1200 continues to 1206; if this format change is not configured (No), flowchart 1200 continues to 1207.

At 1207, it is determined of the configuration received by the UE from the network node configures the UE to extend the energy information bits encoded in its BSR. In some aspects, 1204 may be performed by the component 198. For example, referring again to FIG. 5, the configuration 510 received by the UE 502 from the gNB 504 may configure the UE 502 to extend (e.g., in a positive or negative manner) the number of energy information bits encoded (e.g., 702/704 as shown in FIG. 7; 802/804, 806/808 as shown in FIG. 8). That is, the UE 502 may be configured by the configuration 510 to increase or decrease the encoded energy information, e.g., a change from 3 bits to another number of bits, as indicated by the dotted arrows depicted with respect to the energy information bits encoded (e.g., 702/704 as shown in FIG. 7; 802/804, 806/808 as shown in FIG. 8). If it is determined at 1207 that this format change is configured (Yes), flowchart 1200 continues to 1208; if this bit extension is not configured (No), flowchart 1200 continues to 1209.

At 1209, it is determined of the configuration received by the UE from the network node configures the UE to utilize an entire LCG ID for the energy information bits encoded in its BSR. In some aspects, 1204 may be performed by the component 198. For example, referring again to FIG. 5, the configuration 510 received by the UE 502 from the gNB 504 may include both of the configurations described above for 1205/1207. If it is determined at 1209 that the entire LCG ID is configured (Yes), flowchart 1200 continues to 1210; if the entire LCG ID is not configured (No), flowchart 1200 continues to 1212.

At 1206, the UE may generate the BSR for each LCG of the set of LCGs to include the energy information encoded in the BSR based on the field configuration information received in the configuration, including to replace at least one field in the long BSR format or the long truncated BSR format with a short BSR format, the energy information being encoded in place of at least a portion of a LCG ID for the BSR, the LCG ID being a number of bits in the short BSR format. In some aspects, 1206 may be performed by the component 198. For example, referring again to FIG. 5, the configuration 510 may be transmitted by the gNB 504 and received by the UE 502. The UE 502 may then generate (at 512) the BSR (diagram 700 as shown in FIG. 7; diagram 800 as shown in FIG. 8) for each LCG of the set of LCGs (e.g., LCG ID 0 as shown in FIG. 7; LCG ID 0, LCG ID 7 as shown in FIG. 8) to include the energy information, as encoded in the BSR (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10), e.g., based on the field configuration information received in the configuration 510 for the set of BSRs. The energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) may be information for an energy report and/or an energy request, in aspects, and may include energy information encoded in place of an LCG ID in a BSR and/or buffer status information in BSR status fields (e.g., energy information 702 as shown in FIG. 7; energy information 802, 806 as shown in FIG. 8). That is, in aspects, to generate the BSRs, the UE 502 may replace (at 512) a portion of a long/long truncated BSR with a short/short truncated BSR configuration, or put another way, change a portion of a long BSR format to be in the configuration of a short BSR format (e.g., 702/704 as shown in FIG. 7; 802/804, 806/808 as shown in FIG. 8 (as compared, e.g., to the BSRs 706 as shown in FIG. 7).

At 1208, the UE may generate the BSR for each LCG of the set of LCGs to include the energy information encoded in the BSR based on the field configuration information received in the configuration and include second energy information encoded in place of buffer status information for the BSR based on the field configuration information received in the configuration. In some aspects, 1208 may be performed by the component 198. For example, referring again to FIG. 5, the configuration 510 may be transmitted by the gNB 504 and received by the UE 502. The UE 502 may then generate (at 512) the BSR (diagram 700 as shown in FIG. 7; diagram 800 as shown in FIG. 8) for each LCG of the set of LCGs (e.g., LCG ID 0 as shown in FIG. 7; LCG ID 0, LCG ID 7 as shown in FIG. 8) to include the energy information, as encoded in the BSR (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10), e.g., based on the field configuration information received in the configuration 510 for the set of BSRs. The energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) may be information for an energy report and/or an energy request, in aspects, and may include energy information encoded in place of an LCG ID in a BSR and/or buffer status information in BSR status fields (e.g., energy information 702 as shown in FIG. 7; energy information 802, 806 as shown in FIG. 8). That is, in aspects, to generate the BSRs, the configuration 510 received by the UE 502 from the gNB 504 may configure the UE 502 to change BSR format (e.g., change a portion of a long BSR format to be in the configuration of a short BSR format (702/704 as shown in FIG. 7; 802/804, 806/808 as shown in FIG. 8, as compared, e.g., to the BSRs 706 as shown in FIG. 7)) and to extend (e.g., in a positive or negative manner) the number of energy information bits encoded (e.g., 702/704 as shown in FIG. 7; 802/804, 806/808 as shown in FIG. 8). The UE 502 may be configured by the configuration 510 to increase or decrease the encoded energy information, e.g., a change from 3 bits to another number of bits, e.g., 4, 5, 6, etc. bits, as indicated by the dotted arrows depicted with respect to the energy information bits encoded (e.g., 702/704 as shown in FIG. 7; 802/804, 806/808 as shown in FIG. 8) and to change a portion of a long BSR format to be in the configuration of a short BSR format (702/704 as shown in FIG. 7; 802/804, 806/808 as shown in FIG. 8, as compared, e.g., to the BSRs 706 as shown in FIG. 7).

At 1210, the UE may generate the BSR, in a long BSR format or a long truncated BSR format, for each LCG of the set of LCGs to include the energy information encoded in the BSR based on the field configuration information received in the configuration, including to: reduce a total number of bits for LCG IDs in the BSR to a first set of bits, respectively corresponding to a reduced set of buffer status information fields, a remaining number of bits of the total number of bits including a second set of bits, encode energy field IDs in the second set of bits, and encode second energy information in place of buffer status information in one or more BSR fields corresponding to the second set of bits for the BSR based on the field configuration information received in the configuration. In some aspects, 1210 may be performed by the component 198. For example, referring again to FIG. 5, referring again to FIG. 5, the configuration 510 may be transmitted by the gNB 504 and received by the UE 502. The UE 502 may then generate (at 512) the BSR (e.g., diagram 900 as shown in FIG. 9) for each LCG of the set of LCGs (e.g., up to 3 groups of 8 bits for energy information when BSRs≤5 as shown in FIG. 9) to include the energy information, as encoded in the BSR (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10), e.g., based on the field configuration information received in the configuration 510 for the set of BSRs. The energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) may be information for an energy report and/or an energy request, in aspects, and may include energy information encoded in place of an LCG ID in a BSR and buffer status information in BSR status fields (e.g., energy information 902 as shown in FIG. 9). That is, in aspects, to generate the BSRs, the configuration 510 received by the UE 502 from the gNB 504 may configure the UE 502 to utilize all 8 bits of a BSR buffer status field for energy information bits encoded (e.g., energy information 902 as shown in FIG. 9), and to utilized more than one buffer status field, as indicated by the dotted arrows depicted with respect to the energy information bits encoded (e.g., 902 as shown in FIG. 9).

At 1212, the UE may generate the BSR for each LCG of the set of LCGs to include the energy information encoded in the BSR based on the field configuration information received in the configuration. In some aspects, 1212 may be performed by the component 198. For example, referring again to FIG. 5, the configuration 510 may be transmitted by the gNB 504 and received by the UE 502. The UE 502 may then generate (at 512) the BSR (diagram 700 as shown in FIG. 7; diagram 800 as shown in FIG. 8; diagram 900 as shown in FIG. 9) for each LCG of the set of LCGs (e.g., LCG ID 0 as shown in FIG. 7; LCG ID 0, LCG ID 7 as shown in FIG. 8; LCG ID 7, LCG IDs 5-7 as shown in FIG. 9) to include the energy information, as encoded in the BSR (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10), e.g., based on the field configuration information received in the configuration 510 for the set of BSRs. The energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) may be information for an energy report and/or an energy request, in aspects, and may include energy information encoded in place of an LCG ID in a BSR and/or buffer status information in BSR status fields (e.g., energy information 702 as shown in FIG. 7; energy information 802, 806 as shown in FIG. 8; energy information 902 as shown in FIG. 9).

At 1214, the UE transmits, for the network node, a BSR for each LCG of the set of LCGs, where the BSR for each LCG of the set of LCGs includes energy information, where the energy information is encoded in the BSR based on the field configuration information in the configuration. In some aspects, 1214 may be performed by the component 198. The UE 502 may transmit the generated BSR(s) 514 (diagram 700 as shown in FIG. 7; diagram 800 as shown in FIG. 8; diagram 900 as shown in FIG. 9) for each LCG of the set of LCGs to the gNB 504. In aspects, the BSR(s) may include the energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) (for reporting/requesting) as encoded in the BSR (e.g., LCG ID 0 as shown in FIG. 7; LCG ID 0, LCG ID 7 as shown in FIG. 8; LCG ID 7, LCG IDs 5-7 as shown in FIG. 9) based on the configuration 510 (e.g., the field configuration information therein), and may be transmitted from the UE 502 to the gNB 504 via MAC-CE.

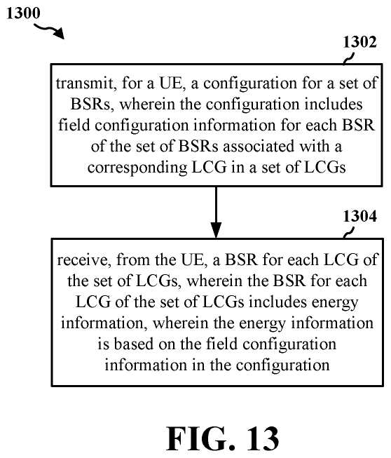

FIG. 13 is a flowchart 1300 of a method of wireless communication, in various aspects. The method may be performed by a base station (e.g., the base station 102; the gNB 504; the network entity 1502. At 1302, the network entity transmits, for a UE, a configuration for a set of buffer status reports (BSRs), where the configuration includes field configuration information for each BSR of the set of BSRs associated with a corresponding logical channel group (LCG) in a set of LCGs. In some aspects, 1302 may be performed by the component 199. At 1304, the network entity receives, from the UE, a BSR for each LCG of the set of LCGs, where the BSR for each LCG of the set of LCGs includes energy information, where the energy information is encoded in the BSR based on the field configuration information in the configuration. In some aspects, 1304 may be performed by the component 199.

For example, referring again to FIG. 5, the UE 502 may receive the configuration 510 for a set of BSRs that is transmitted by the gNB 508. The configuration 510 and associated information/field configuration information therein may be generated (at 508) by the gNB 504 based on the indication 506 from the UE 502, and may be generated to configure the UE 502 to encode energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) in the BSR(s) based on a priority of the BSR/associated LCG (e.g., a lowest priority(ies)), a specific LCG ID(s), a number of BSRs, etc., and may include a pre-configuration (e.g., 510 as shown in FIG. 5) for encoding the energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10). The information/field configuration information in the configuration 510 for the set of BSRs may be for each BSR in a set of BSRs associated with corresponding LCGs in a set of LCGs (e.g., LCG ID 0 in FIG. 7; LCG ID 0, LCG ID 7 as shown in FIG. 8; LCG ID 7, LCG IDs 5-7 as shown in FIG. 9). The configuration 510 may be transmitted by the gNB 504 and received by the UE 502. The gNB 504 may then receive the generated BSR(s) 514 (diagram 700 as shown in FIG. 7; diagram 800 as shown in FIG. 8; diagram 900 as shown in FIG. 9) for each LCG of the set of LCGs transmitted from the UE 502. In aspects, the BSR(s) may include the energy information (e.g., for reporting/requesting) as encoded in the BSR (e.g., LCG ID 0 as shown in FIG. 7; LCG ID 0, LCG ID 7 as shown in FIG. 8; LCG ID 7, LCG IDs 5-7 as shown in FIG. 9) based on the configuration 510 (e.g., the field configuration information therein), and may be transmitted from the UE 502 and received by the gNB 504 via MAC-CE.

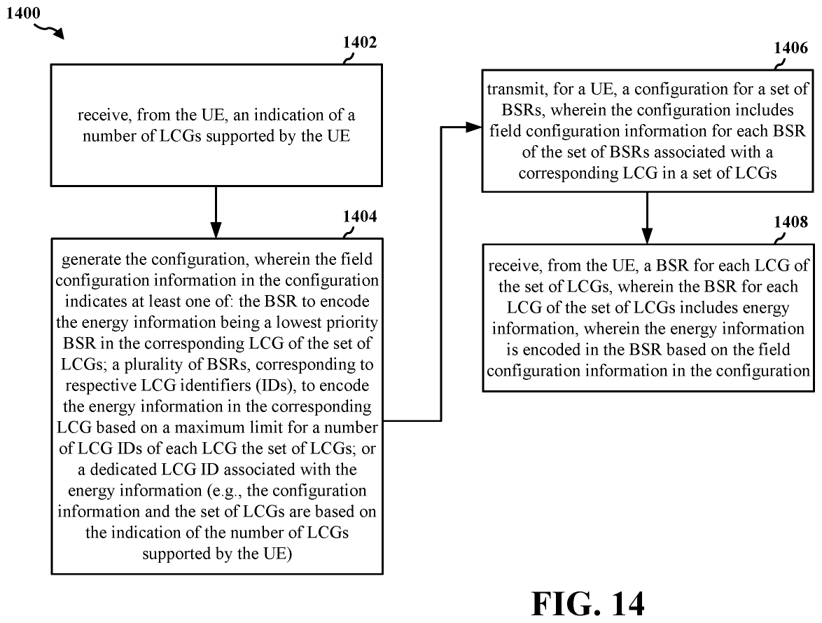

FIG. 14 is a flowchart 1400 of a method of wireless communication, in various aspects. The method may be performed by a base station (e.g., the base station 102; the gNB 504; the network entity 1502. At 1402, the network node may receive, from the UE, an indication of a number of LCGs supported by the UE. In some aspects, 1402 may be performed by the component 199. For example, referring to FIG. 5, the gNB 504 (or one or more components of the gNB 504) may receive from the UE 502 the indication 506 of a number of LCGs supported (e.g., LCG ID 0 as shown in FIG. 7; LCG ID 0, LCG ID 7 as shown in FIG. 8; LCG ID 7, LCG IDs 5-7 as shown in FIG. 9) by the UE 502. The indication 506 may also include a number of data radio bearers (DRB s) supported by the UE 502, in aspects.

At 1404, the network entity may generate the configuration. The field configuration information in the configuration may indicate at least one of: the BSR to encode energy information being a lowest priority BSR in the corresponding LCG of the set of LCGs, a plurality of BSRs, corresponding to respective LCG identifiers (IDs), to encode the energy information in the corresponding LCG based on a maximum limit for a number of LCG IDs of each LCG the set of LCGs, or a dedicated LCG ID associated with the energy information. The configuration information and the set of LCGs may be based on the indication of the number of LCGs supported by the UE. In some aspects, 1404 may be performed by the component 199. For example, referring again to FIG. 5, the gNB 504 may generate (at 508) configuration information for a configuration 510, for a set of BSRs (diagram 700 as shown in FIG. 7; diagram 800 as shown in FIG. 8; diagram 900 as shown in FIG. 9), which may include field configuration information for formatting a BSR(s) (diagram 700 as shown in FIG. 7; diagram 800 as shown in FIG. 8; diagram 900 as shown in FIG. 9) at the UE 502 to piggyback/multiplex energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) therein. The configuration 510 and associated information/field configuration information may be generated (at 508) based on the indication 506 from the UE 502, and may be generated to configure the UE 502 to encode energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) in the BSR(s) (e.g., diagram 700 as shown in FIG. 7; diagram 800 as shown in FIG. 8; diagram 900 as shown in FIG. 9) based on a priority of the BSR/associated LCG (e.g., a lowest priority(ies)), a specific LCG ID(s), a number of BSRs, etc. The configuration 510 may be generated (at 508) to include a pre-configuration for encoding the energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10). The information/field configuration information in the configuration 510 for the set of BSRs may be for each BSR in a set of BSRs (diagram 700 as shown in FIG. 7; diagram 800 as shown in FIG. 8; diagram 900 as shown in FIG. 9) associated with corresponding LCGs in a set of LCGs (e.g., LCG ID 0 as shown in FIG. 7; LCG ID 0, LCG ID 7 as shown in FIG. 8; LCG ID 7, LCG IDs 5-7 as shown in FIG. 9). For instance, based on the indicated number of supported LCGs in the indication 506 from the UE 502, the gNB 504 may generate (at 508) the information/field configuration information in the configuration 510 for one or more BSRs of the indicated LCGs.

At 1406, the network entity transmits, for a UE, a configuration for a set of buffer status reports (BSRs), where the configuration includes field configuration information for each BSR of the set of BSRs associated with a corresponding logical channel group (LCG) in a set of LCGs. In some aspects, 1406 may be performed by the component 199. For example, referring again to FIG. 5, the UE 502 may receive the configuration 510 for a set of BSRs that is transmitted by the gNB 508. The configuration 510 and associated information/field configuration information therein may be generated (at 508) by the gNB 504 based on the indication 506 from the UE 502, and may be generated to configure the UE 502 to encode energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10) in the BSR(s) (diagram 700 as shown in FIG. 7; diagram 800 as shown in FIG. 8; diagram 900 as shown in FIG. 9) based on a priority of the BSR/associated LCG (e.g., a lowest priority(ies)), a specific LCG ID(s), a number of BSRs, etc., and may include a pre-configuration (e.g., 510 as shown in FIG. 5) for encoding the energy information (e.g., minimum gaps g1, g2, g3, g4, g5 for consecutive allocations 602, 604, 606, 608, 610 as shown in FIG. 6; energy information 702 as shown in FIG. 7; energy information 802, 806 as shown in FIG. 8; energy information 902 as shown in FIG. 9; energy information portion 1010, 1012 as shown in FIG. 10). The information/field configuration information in the configuration 510 for the set of BSRs may be for each BSR in a set of BSRs associated with corresponding LCGs in a set of LCGs (e.g., LCG ID 0 in FIG. 7; LCG ID 0, LCG ID 7 as shown in FIG. 8; LCG ID 7, LCG IDs 5-7 as shown in FIG. 9).

At 1408, the network entity receives, from the UE, a BSR for each LCG of the set of LCGs, where the BSR for each LCG of the set of LCGs includes energy information, where the energy information is encoded in the BSR based on the field configuration information in the configuration. In some aspects, 1408 may be performed by the component 199. For example, referring again to FIG. 5, the configuration 510 may be transmitted by the gNB 504 and received by the UE 502. The gNB 504 may then receive the generated BSR(s) 514 (diagram 700 as shown in FIG. 7; diagram 800 as shown in FIG. 8; diagram 900 as shown in FIG. 9) for each LCG of the set of LCGs transmitted from the UE 502. In aspects, the BSR(s) may include the energy information (e.g., for reporting/requesting) as encoded in the BSR (e.g., LCG ID 0 as shown in FIG. 7; LCG ID 0, LCG ID 7 as shown in FIG. 8; LCG ID 7, LCG IDs 5-7 as shown in FIG. 9) based on the configuration 510 (e.g., the field configuration information therein), and may be transmitted from the UE 502 and received by the gNB 504 via MAC-CE.

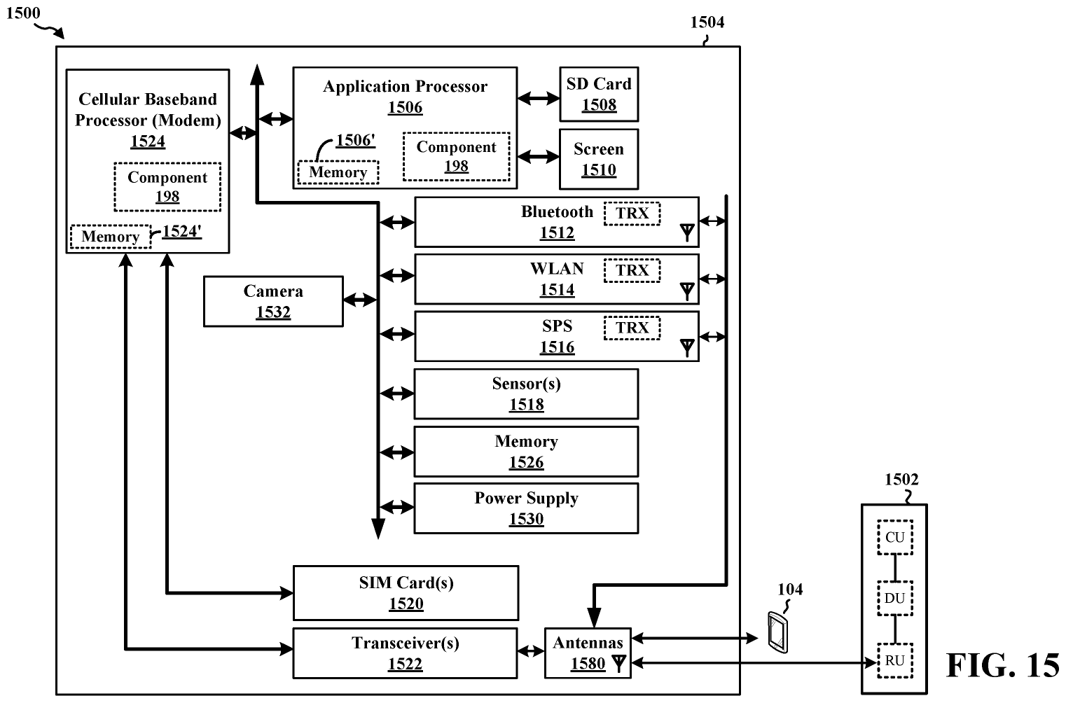

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the component 198 is configured to receive, from a network node, a configuration for a set of BSRs, where the configuration includes field configuration information for each BSR of the set of BSRs associated with a corresponding LCG in a set of LCGs. The component 198 is also configured to transmit, for the network node, a BSR for each LCG of the set of LCGs, where the BSR for each LCG of the set of LCGs includes energy information, where the energy information is encoded in the BSR based on the field configuration information in the configuration. The component 198 may also be configured to generate the BSR for each LCG of the set of LCGs to include the energy information encoded in the BSR based on the field configuration information received in the configuration. The component 198, to generate the BSR, where the BSR has a long BSR format or a long truncated BSR format, may also be configured to replace at least one field in the long BSR format or the long truncated BSR format with a short BSR format, the energy information being encoded in place of at least a portion of a LCG ID for the BSR, the LCG ID being a number of bits in the short BSR format. The component 198 may also be configured to generate the BSR to include second energy information encoded in place of buffer status information for the BSR based on the field configuration information received in the configuration. The component 198 may also be configured to transmit, for the network node, an indication of a number of LCGs supported by the UE, where the configuration information and the set of LCGs are based on the indication of the number of LCGs supported by the UE. The component 198 may also be configured to generate the BSR, in a long BSR format or a long truncated BSR format, where to generate the BSR in the long BSR format or the long truncated BSR format, the component 198 is configured to reduce a total number of bits for LCG identifiers (IDs) in the BSR to a first set of bits, respectively corresponding to a reduced set of buffer status information fields, a remaining number of bits of the total number of bits including a second set of bits, encode energy field IDs in the second set of bits, and encode second energy information in place of buffer status information in one or more BSR fields corresponding to the second set of bits for the BSR based on the field configuration information received in the configuration. The component 198 may be further configured to perform any of the aspects described in connection with FIGS. 11, 12, 13, 14, and/or performed by the UE in FIG. 5. The component 198 may be within the cellular baseband processor 1524, the application processor 1506, or both the cellular baseband processor 1524 and the application processor 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for receiving, from a network node, a configuration for a set of buffer status reports (BSRs), where the configuration includes field configuration information for each BSR of the set of BSRs associated with a corresponding logical channel group (LCG) in a set of LCGs. The apparatus 1504, and in particular the cellular baseband processor 1524 and/or the application processor 1506, also includes means for transmitting, for the network node, a BSR for each LCG of the set of LCGs, where the BSR for each LCG of the set of LCGs includes energy information, where the energy information is encoded in the BSR based on the field configuration information in the configuration. The application processor 1506 may include means for generating the BSR for each LCG of the set of LCGs to include the energy information encoded in the BSR based on the field configuration information received in the configuration. The application processor 1506, in generating the BSR, where the BSR has a long BSR format or a long truncated BSR format, may include means for replacing at least one field in the long BSR format or the long truncated BSR format with a short BSR format, the energy information being encoded in place of at least a portion of a LCG ID for the BSR, the LCG ID being a number of bits in the short BSR format. The application processor 1506 may include means for generating the BSR to include second energy information encoded in place of buffer status information for the BSR based on the field configuration information received in the configuration. The application processor 1506 may include means for transmitting, for the network node, an indication of a number of LCGs supported by the UE, where the configuration information and the set of LCGs are based on the indication of the number of LCGs supported by the UE. The application processor 1506 may include means for generating the BSR, in a long BSR format or a long truncated BSR format, where generating the BSR in the long BSR format or the long truncated BSR format, the application processor 1506 may include means for reducing a total number of bits for LCG identifiers (IDs) in the BSR to a first set of bits, respectively corresponding to a reduced set of buffer status information fields, a remaining number of bits of the total number of bits including a second set of bits, encoding energy field IDs in the second set of bits, and encoding second energy information in place of buffer status information in one or more BSR fields corresponding to the second set of bits for the BSR based on the field configuration information received in the configuration. The application processor 1506 may further include means for performing any of the aspects described in connection with FIGS. 11, 12, 13, 14, and/or performed by the UE in FIG. 5. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

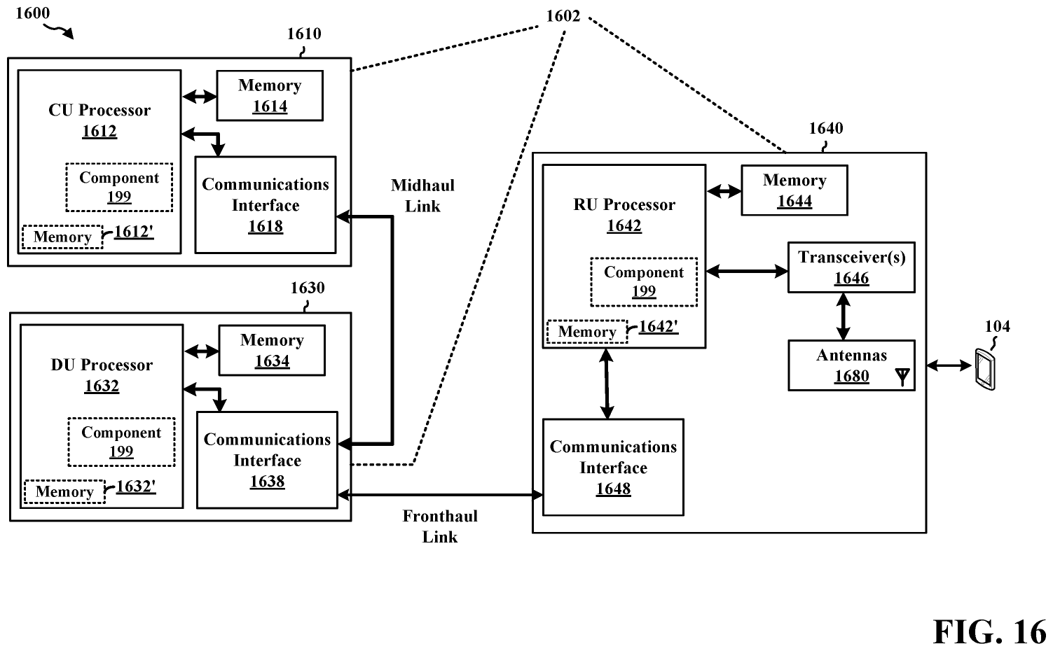

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit, for a UE, a configuration for a set of BSRs, where the configuration includes field configuration information for each BSR of the set of BSRs associated with a corresponding logical channel group (LCG) in a set of LCGs. The component 199 is also configured to receive, from the UE, a BSR for each LCG of the set of LCGs, where the BSR for each LCG of the set of LCGs includes energy information, where the energy information is encoded in the BSR based on the field configuration information in the configuration. The component 199 may also be configured to generate the configuration, where the field configuration information in the configuration indicates at least one of: the BSR to encode the energy information being a lowest priority BSR in the corresponding LCG of the set of LCGs, a plurality of BSRs, corresponding to respective LCG IDs, to encode the energy information in the corresponding LCG based on a maximum limit for a number of LCG IDs of each LCG the set of LCGs, or a dedicated LCG ID associated with the energy information. The component 199 may also be configured to receive, from the UE, an indication of a number of LCGs supported by the UE, where the configuration information and the set of LCGs are based on the indication of the number of LCGs supported by the UE. The component 199 may be further configured to perform any of the aspects described in connection with FIGS. 11, 12, 13, 14, and/or performed by the network entity (e.g., gNB) in FIG. 5. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for transmitting, for a UE, a configuration for a set of BSRs, where the configuration includes field configuration information for each BSR of the set of BSRs associated with a corresponding LCG in a set of LCGs. In the configuration, the network entity 1602 includes means for receiving, from the UE, a BSR for each LCG of the set of LCGs, where the BSR for each LCG of the set of LCGs includes energy information, where the energy information is encoded in the BSR based on the field configuration information in the configuration. In one configuration, the network entity 1602 may include means for generating the configuration information, where the field configuration information in the configuration indicates at least one of: the BSR to encode the energy information being a lowest priority BSR in the corresponding LCG of the set of LCGs, a plurality of BSRs, corresponding to respective LCG IDs, to encode the energy information in the corresponding LCG based on a maximum limit for a number of LCG IDs of each LCG the set of LCGs, or a dedicated LCG ID associated with the energy information. The network entity 1602 may include means for performing any of the aspects described in connection with FIGS. 11, 12, 13, 14, and/or performed by the network entity (e.g., gNB) in FIG. 5. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

Some aspects of wireless communications (e.g., 5G NR) may be designed to provide support for EH and backscatter communications, which may be utilized by EH and/or low/zero power devices. Communication with such UEs, including power-constrained devices herein, generally, utilizes power that may be limited. The described aspects provide for a UE to inform a network entity or sidelink UE with energy information (e.g., for reporting and/or requesting) such that a configuration for the UE may be implement to enable communications therewith in a manner that takes the UE's energy usage/collecting capabilities. The described aspects provide for a UE to receive, from a network node, a configuration (e.g., based on UE-indicated support for LCGs) for a set of buffer status reports (BSRs), where the configuration includes field configuration information for each BSR of the set of BSRs associated with a corresponding logical channel group (LCG) in a set of LCGs. The described aspects also provide for the UE to transmit, for the network node, a BSR for each LCG of the set of LCGs, where the BSR for each LCG of the set of LCGs includes energy information, where the energy information is encoded in the BSR based on the field configuration information in the configuration. Accordingly, the UE and the network entity (or the sidelink UE) are enabled to communication in a manner for which the UE's energy usage/collecting capabilities are taken into consideration.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without specifying a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE) or a wireless device, including a memory and at least one processor coupled to the memory and, based at least in part on information stored in the memory, the at least one processor is configured to: receive, from a network node, a configuration for a set of buffer status reports (BSRs), where the configuration includes field configuration information for each BSR of the set of BSRs associated with a corresponding logical channel group (LCG) in a set of LCGs, and transmit, for the network node, a BSR for each LCG of the set of LCGs, where the BSR for each LCG of the set of LCGs includes energy information, and where the energy information is encoded in the BSR based on the field configuration information in the configuration.

Aspect 2 is the apparatus of aspect 1, where the configuration further includes a pre-configuration associated with encoding each of the set of BSRs, where the energy information is encoded based on the pre-configuration.

Aspect 3 is the apparatus of any of aspects 1 and 2, where the energy information is multiplexed or piggybacked in the BSR for each LCG of the set of LCGs.

Aspect 4 is the apparatus of any of aspects 1 to 3, where each LCG of the set of LCGs is associated with a buffer, where the buffer includes a status associated with the BSR.

Aspect 5 is the apparatus of any of aspects 1 to 4, where the energy information includes an energy report or an energy request.

Aspect 6 is the apparatus of aspect 5, where the energy report includes at least one of: a time offset, from the energy report, to send an uplink (UL) or a downlink (DL); a time gap between two consecutive allocations that includes at least one reception and at least one transmission; a charging profile from at least one of one or more energy harvesting (EH) technologies supported by the UE or each EH technology of the one or more EH technologies; a charging satisfaction that indicates meeting or exceeding a threshold of configured energy at one or more time slots; a discharging or power consumption profile based in part on at least one of a current scheduling of data at the UE, grants, transmission power, or a battery or energy storage discharging rate associated with imperfections or leakage; a battery status profile that includes at least one of a current battery status, a predicted battery status over at least one of time, the one or more time slots, or one or more time units; at least one EH cycle or time during a harvesting time duration including at least one time unit; an amount of DL data to receive and decode in a number of subsequent reception grants or a decoding time duration; an amount of UL data to transmit in a number of next transmission grants or a transmission time duration; or at least one of a DL transport block (TB) size, an UL TB size, or a number of bits that the UE is configured to process in a given time interval associated with processing or a transmission, and a number of TB s within each time interval.

Aspect 7 is the apparatus of aspect 6, where the time gap is associated with a gap profile across time; where the charging profile includes a charging rate or a predicted charging rate of the UE for at least one of a number of slots, a number of times, a current time, or charging time period; where the charging satisfaction includes the energy information in one or more K1 bits; where the discharging or power consumption profile includes at least one of a discharging rate or a power consumption at the current time or a consumption time period; where the at least one EH cycle or the time during the harvesting time duration: is configured based on at least one of an L1 configuration, an L2 configuration, or an L3 configuration, or on a static configuration or a semi-static configuration associated with the network node, and includes an EH profile or a current-time UE EH characteristic that corresponds to a configured time window for reporting; where the number of next reception grants associated with the amount of DL data is pre-configured or is configured based on at least one of the L1 configuration, the L2 configuration, or the L3 configuration; where the amount of UL data to transmit is associated with at least one power level of the UE, each of the at least one power level being a configured power level of the UE, a pre-configured power level of the UE, or based on a reference power level; where the number of bits is associated with sidelink (SL) communication; or where at least one of the DL TB size, the UL TB size, or the number of bits is associated with at least one of: multiple time intervals that are respectively pre-configured or configured based on at least one of the L1 configuration, the L2 configuration, or the L3 configuration, or a TB size profile.

Aspect 8 is the apparatus of aspect 5, where the energy request includes at least one of: a charging rate to support an uplink (UL) BSR; or an additional charging rate from at least one wireless energy provider and that is in addition to any currently received charging rates.

Aspect 9 is the apparatus of aspect 8, where the charging rate is associated with at least one of a radio frequency (RF) wireless charging, a laser-based charging, a light-based charging, a thermal-based charging, a wind-based charging, or a printed battery; or where the charging rate is based on a charging profile over time.

Aspect 10 is the apparatus of any of aspects 1 to 9, where the BSR is transmitted in a medium access control (MAC) control element (MAC-CE).

Aspect 11 is the apparatus of any of aspects 1 to 10, where the BSR includes at least two BSRs in a LCG.

Aspect 12 is the apparatus of any of aspects 1 to 11, where the field configuration information in the configuration indicates at least one of: the BSR to encode the energy information being a lowest priority BSR in a LCG, or a plurality of BSRs to encode the energy information in the LCG.

Aspect 13 is the apparatus of any of aspects 1 to 12, where the at least one processor is further configured to: generate the BSR for each LCG of the set of LCGs to include the energy information encoded in the BSR based on the field configuration information received in the configuration.

Aspect 14 is the apparatus of aspect 13, where the BSR has a long BSR format or a long truncated BSR format, and where to generate the BSR the at least one processor is configured to: replace at least one field in the long BSR format or the long truncated BSR format with a short BSR format, the energy information being encoded in place of at least a portion of a LCG identifier (ID) for the BSR, the LCG ID being a number of bits in the short BSR format.

Aspect 15 is the apparatus of aspect 15, where prior energy information was provided to the network node, and the configuration is associated with at least one of the prior energy information or BSR priority for one or more LCG identifiers (IDs); and where the at least a portion of each of the one or more LCG IDs includes less than a total number of bits of the LCG ID information based on the field configuration information received in the configuration.

Aspect 16 is the apparatus of aspect 13, where prior energy information was provided to the network node, and the configuration is associated with at least one of the prior energy information or BSR priority for one or more LCG identifiers (IDs), and where the energy information is encoded in place of a total number of bits of the LCG ID information and of the buffer status information for one or more BSRs, based on the field configuration information received in the configuration.

Aspect 17 is the apparatus of any of aspects 1 to 11, where the at least one processor is further configured to: generate the BSR to include second energy information encoded in place of buffer status information for the BSR based on the field configuration information received in the configuration.

Aspect 17 is the apparatus of any of aspects 1 to 11, where the at least one processor is further configured to: generate the BSR, in a long BSR format or a long truncated BSR format, where to generate the BSR in the long BSR format or the long truncated BSR format, the at least one processor is configured to: reduce a total number of bits for LCG identifiers (IDs) in the BSR to a first set of bits, respectively corresponding to a reduced set of buffer status information fields, a remaining number of bits of the total number of bits including a second set of bits, encode energy field IDs in the second set of bits, and encode second energy information in place of buffer status information in one or more BSR fields corresponding to the second set of bits for the BSR based on the field configuration information received in the configuration.

Aspect 19 is the apparatus of any of aspects 1 to 18, where the apparatus further includes at least one transceiver coupled to the at least one processor, and where the at least one processor is further configured to: transmit, for the network node, an indication of a number of LCGs supported by the UE via the at least one transceiver, where the configuration information and the set of LCGs are based on the indication of the number of LCGs supported by the UE.

Aspect 20 is an apparatus for wireless communication at a network entity, including a memory and at least one processor coupled to the memory and, based at least in part on information stored in the memory, the at least one processor is configured to: transmit, for a user equipment (UE), a configuration for a set of buffer status reports (BSRs), where the configuration includes field configuration information for each BSR of the set of BSRs associated with a corresponding logical channel group (LCG) in a set of LCGs, and receive, from the UE, a BSR for each LCG of the set of LCGs, where the BSR for each LCG of the set of LCGs includes energy information, and where the energy information is encoded in the BSR based on the field configuration information in the configuration.

Aspect 21 is an apparatus of aspect 20, where the configuration further includes a pre-configuration associated with encoding each of the set of BSRs, where the energy information is encoded based on the pre-configuration.

Aspect 22 is an apparatus of any of aspects 20 and 21, where the energy information is multiplexed or piggybacked in the BSR for each LCG of the set of LCGs.

Aspect 23 is an apparatus of any of aspects 20 to 22, where each LCG of the set of LCGs is associated with a buffer, where the buffer includes a status associated with the BSR.

Aspect 24 is an apparatus of any of aspects 20 to 23, where the energy information includes an energy report or an energy request, and where the energy report includes at least one of: a time offset, from the energy report, to send an uplink (UL) or a downlink (DL); a time gap between two consecutive allocations that includes at least one reception and at least one transmission; a charging profile from at least one of one or more energy harvesting (EH) technologies supported by the UE or each EH technology of the one or more EH technologies; a charging satisfaction that indicates meeting or exceeding a threshold of configured energy at one or more time slots; a discharging or power consumption profile based in part on at least one of a current scheduling of data at the UE, grants, transmission power, or a battery or energy storage discharging rate associated with imperfections or leakage; a battery status profile that includes at least one of a current battery status, a predicted battery status over at least one of time, the one or more time slots, or one or more time units; at least one EH cycle or time during a harvesting time duration including at least one time unit; an amount of DL data to receive and decode in a number of subsequent reception grants or a decoding time duration; an amount of UL data to transmit in a number of next transmission grants or a transmission time duration; or at least one of a DL transport block (TB) size, an UL TB size, or a number of bits that the UE is configured to process in a given time interval associated with processing or a transmission, and a number of TB s within each time interval; or where the energy request includes at least one of: a charging rate to support an uplink (UL) BSR; or an additional charging rate from at least one wireless energy provider and that is in addition to any currently received charging rates.

Aspect 25 is an apparatus of any of aspects 20 to 24, where the BSR is received in a medium access control (MAC) control element (MAC-CE).

Aspect 26 is an apparatus of any of aspects 20 to 25, where the at least one processor is further configured to: generate the configuration, where the field configuration information in the configuration indicates at least one of: the BSR to encode the energy information being a lowest priority BSR in the corresponding LCG of the set of LCGs; a plurality of BSRs, corresponding to respective LCG identifiers (IDs), to encode the energy information in the corresponding LCG based on a maximum limit for a number of LCG IDs of each LCG the set of LCGs; or a dedicated LCG ID associated with the energy information.

Aspect 27 is an apparatus of aspects 26, where generating the configuration includes specifying a subset of LCGs in the set of LCGs based on a limit associated with the respective LCG IDs for a provision of BSR information, where the limit is less than a total number of LCG IDs of the at least one LCG, and where the received energy information corresponds to at least one LCG ID that is included with at least one respective LCG in the set of LCGs that is outside of the subset of LCGs.

Aspect 28 is an apparatus of any of aspects 20 to 27, where the apparatus further includes at least one of an antenna or a transceiver coupled to the at least one processor, where the at least one processor is further configured to: receive, from the UE, an indication of a number of LCGs supported by the UE via the at least one of the antenna or the transceiver, where the configuration information and the set of LCGs are based on the indication of the number of LCGs supported by the UE.

Aspect 29 is a method of wireless communication for implementing any of aspects 1 to 28.

Aspect 30 is an apparatus for wireless communication including means for implementing any of aspects 1 to 28.

Aspect 31 is a computer-readable medium (e.g., a non-transitory computer-readable medium) storing computer executable code, the code when executed by at least one processor causes the at least one processor to implement any of aspects 1 to 28.

What is claimed is:

1. An apparatus for wireless communication at a user equipment (UE), comprising:
a memory; and
at least one processor coupled to the memory and, based at least in part on information stored in the memory, the at least one processor is configured to:
receive, from a network node, a configuration for a set of buffer status reports (BSRs), wherein the configuration includes field configuration information for each BSR of the set of BSRs associated with a corresponding logical channel group (LCG) in a set of LCGs; and
transmit, for the network node, a BSR for each LCG of the set of LCGs, wherein the BSR for each LCG of the set of LCGs includes energy information, wherein the energy information is based on the field configuration information in the configuration.

2. The apparatus of claim 1, wherein the configuration further includes a pre-configuration associated with an encoding process for each of the set of BSRs, wherein the energy information is configured to be encoded based on the pre-configuration.

3. The apparatus of claim 1, wherein the energy information is configured to be multiplexed or piggybacked in the BSR for each LCG of the set of LCGs.

4. The apparatus of claim 1, wherein each LCG of the set of LCGs is associated with a buffer, wherein the buffer includes a status associated with the BSR.

5. The apparatus of claim 1, wherein the energy information includes an energy report or an energy request.

6. The apparatus of claim 5, wherein the energy report includes at least one of:
a time offset, from the energy report, to send an uplink (UL) or a downlink (DL);
a time gap between two consecutive allocations that includes at least one reception and at least one transmission;
a charging profile from at least one of one or more energy harvesting (EH) technologies supported by the UE or each EH technology of the one or more EH technologies;
a charging satisfaction that indicates meeting or exceeding a threshold of configured energy at one or more time slots;
a discharging or power consumption profile based in part on at least one of a current scheduling of data at the UE, grants, transmission power, or a battery or energy storage discharging rate associated with imperfections or leakage;
a battery status profile that includes at least one of a current battery status, a predicted battery status over at least one of time, the one or more time slots, or one or more time units;
at least one EH cycle or time during a harvesting time duration including at least one time unit;
an amount of DL data to receive and decode in a number of subsequent reception grants or a decoding time duration;
an amount of UL data to transmit in a number of next transmission grants or a transmission time duration; or
at least one of a DL transport block (TB) size, an UL TB size, or a number of bits that the UE is configured to process in a given time interval associated with processing or a transmission, and a number of TB s within each time interval.

7. The apparatus of claim 6, wherein the time gap is associated with a gap profile across time;
wherein the charging profile includes a charging rate or a predicted charging rate of the UE for at least one of a number of slots, a number of times, a current time, or charging time period;
wherein the charging satisfaction includes the energy information in one or more K1 bits;
wherein the discharging or power consumption profile includes at least one of a discharging rate or a power consumption at the current time or a consumption time period;
wherein the at least one EH cycle or the time during the harvesting time duration:
is configured based on at least one of an L1 configuration, an L2 configuration, or an L3 configuration, or on a static configuration or a semi-static configuration associated with the network node, and
includes an EH profile or a current-time UE EH characteristic that corresponds to a configured time window for reporting;
wherein the number of subsequent reception grants associated with the amount of DL data is pre-configured or is configured based on at least one of the L1 configuration, the L2 configuration, or the L3 configuration;
wherein the amount of UL data to transmit is associated with at least one power level of the UE, each of the at least one power level being a configured power level of the UE, a pre-configured power level of the UE, or based on a reference power level;
wherein the number of bits is associated with sidelink (SL) communication; or
wherein at least one of the DL TB size, the UL TB size, or the number of bits is associated with at least one of:
multiple time intervals that are respectively pre-configured or configured based on at least one of the L1 configuration, the L2 configuration, or the L3 configuration, or
a TB size profile.

8. The apparatus of claim 5, wherein the energy request includes at least one of:
a charging rate to support an uplink (UL) BSR; or
an additional charging rate from at least one wireless energy provider and that is in addition to any currently received charging rates.

9. The apparatus of claim 8, wherein the charging rate is associated with at least one of a radio frequency (RF) wireless charging, a laser-based charging, a light-based charging, a thermal-based charging, a wind-based charging, or a printed battery; or
wherein the charging rate is based on a charging profile over time.

10. The apparatus of claim 1, wherein to transmit the BSR, the at least one processor is configured to transmit the BSR in a medium access control (MAC) control element (MAC-CE).

11. The apparatus of claim 1, wherein the BSR includes at least two BSRs in a LCG.

12. The apparatus of claim 1, wherein the field configuration information in the configuration indicates at least one of:
the BSR configured to encode the energy information being a lowest priority BSR in a LCG; or
a plurality of BSRs configured to encode the energy information in the LCG.

13. The apparatus of claim 1, wherein the at least one processor is further configured to:
generate the BSR for each LCG of the set of LCGs to include the energy information configured to be encoded in the BSR based on the field configuration information received in the configuration.

14. The apparatus of claim 13, wherein the BSR has a long BSR format or a long truncated BSR format, and
wherein to generate the BSR the at least one processor is configured to:
replace at least one field in the long BSR format or the long truncated BSR format with a short BSR format, wherein the energy information is configured to be encoded in place of at least a portion of a LCG identifier (ID) for the BSR, the LCG ID being a number of bits in the short BSR format.

15. The apparatus of claim 13, wherein prior energy information was provided to the network node, and the configuration is associated with at least one of the prior energy information or BSR priority for one or more LCG identifiers (IDs); and
wherein the at least a portion of each of the one or more LCG IDs includes less than a total number of bits of the LCG ID information based on the field configuration information received in the configuration.

16. The apparatus of claim 13, wherein prior energy information was provided to the network node, and the configuration is associated with at least one of the prior energy information or BSR priority for one or more LCG identifiers (IDs); and
wherein the energy information is configured to be encoded in place of a total number of bits of the LCG ID information and of buffer status information for one or more BSRs based on the field configuration information received in the configuration.

17. The apparatus of claim 1, wherein the at least one processor is further configured to:
generate the BSR to include second energy information configured to be encoded in place of buffer status information for the BSR based on the field configuration information received in the configuration.

18. The apparatus of claim 1, wherein the at least one processor is further configured to:
generate the BSR, in a long BSR format or a long truncated BSR format, wherein to generate the BSR in the long BSR format or the long truncated BSR format, the at least one processor is configured to:
reduce a total number of bits for LCG identifiers (IDs) in the BSR to a first set of bits, respectively corresponding to a reduced set of buffer status information fields, a remaining number of bits of the total number of bits including a second set of bits,
encode energy field IDs in the second set of bits, and
encode second energy information in place of buffer status information in one or more BSR fields corresponding to the second set of bits for the BSR based on the field configuration information received in the configuration.

19. The apparatus of claim 1, wherein the at least one processor is further configured to:
transmit, for the network node, an indication of a number of LCGs supported by the UE;
wherein the field configuration information and the set of LCGs are based on the indication of the number of LCGs supported by the UE.

20. A apparatus for wireless communication at a network node, comprising:
a memory; and
at least one processor coupled to the memory and, based at least in part on information stored in the memory, the at least one processor is configured to:
transmit, for a user equipment (UE), a configuration for a set of buffer status reports (BSRs), wherein the configuration includes field configuration information for each BSR of the set of BSRs associated with a corresponding logical channel group (LCG) in a set of LCGs; and
receive, from the UE, a BSR for each LCG of the set of LCGs, wherein the BSR for each LCG of the set of LCGs includes energy information, wherein the energy information is based on the field configuration information in the configuration.

21. The apparatus of claim 20, wherein the configuration further includes a pre-configuration associated with an encoding process for each of the set of BSRs, wherein the energy information is configured to be encoded based on the pre-configuration.

22. The apparatus of claim 20, wherein the energy information is configured to be multiplexed or piggybacked in the BSR for each LCG of the set of LCGs.

23. The apparatus of claim 20, wherein each LCG of the set of LCGs is associated with a buffer, wherein the buffer includes a status associated with the BSR.

24. The apparatus of claim 20, wherein the energy information includes an energy report or an energy request; and
wherein the energy report includes at least one of:
a time offset, from the energy report, to send an uplink (UL) or a downlink (DL);
a time gap between two consecutive allocations that includes at least one reception and at least one transmission;
a charging profile from at least one of one or more energy harvesting (EH) technologies supported by the UE or each EH technology of the one or more EH technologies;
a charging satisfaction that indicates meeting or exceeding a threshold of configured energy at one or more time slots;
a discharging or power consumption profile based in part on at least one of a current scheduling of data at the UE, grants, transmission power, or a battery or energy storage discharging rate associated with imperfections or leakage;
a battery status profile that includes at least one of a current battery status, a predicted battery status over at least one of time, the one or more time slots, or one or more time units;
at least one EH cycle or time during a harvesting time duration including at least one time unit;
an amount of DL data to receive and decode in a number of subsequent reception grants or a decoding time duration;
an amount of UL data to transmit in a number of next transmission grants or a transmission time duration; or
at least one of a DL transport block (TB) size, an UL TB size, or a number of bits that the UE is configured to process in a given time interval associated with processing or a transmission, and a number of TB s within each time interval;
or
wherein the energy request includes at least one of:
a charging rate to support an uplink (UL) BSR; or
an additional charging rate from at least one wireless energy provider and that is in addition to any currently received charging rates.

25. The apparatus of claim 20, wherein to receive the BSR, the at least one processor is configured to receive the BSR in a medium access control (MAC) control element (MAC-CE).

26. The apparatus of claim 20, wherein the at least one processor is further configured to:
generate the configuration, wherein the field configuration information in the configuration indicates at least one of:
the BSR configured to encode the energy information being a lowest priority BSR in the corresponding LCG of the set of LCGs;
a plurality of BSRs, corresponding to respective LCG identifiers (IDs), configured to encode the energy information in the corresponding LCG based on a maximum limit for a number of LCG IDs of each LCG the set of LCGs; or
a dedicated LCG ID associated with the energy information.

27. The apparatus of claim 26, wherein to generate the configuration, the at least one processor is configured to specify a subset of LCGs in the set of LCGs based on a limit associated with the respective LCG IDs for a provision of BSR information, wherein the limit is less than a total number of LCG IDs of the at least one LCG, and wherein the received energy information corresponds to at least one LCG ID that is included with at least one respective LCG in the set of LCGs that is outside of the subset of LCGs.

28. The apparatus of claim 20, wherein the at least one processor is further configured to:
receive, from the UE, an indication of a number of LCGs supported by the UE;
wherein the configuration information and the set of LCGs are based on the indication of the number of LCGs supported by the UE.

29. A method of wireless communication at a user equipment (UE), comprising:
receiving, from a network entity, a configuration for a set of buffer status reports (BSRs), wherein the configuration includes field configuration information for each BSR of the set of BSRs associated with a corresponding logical channel group (LCG) in a set of LCGs; and
transmitting, for the network entity, a BSR for each LCG of the set of LCGs, wherein the BSR for each LCG of the set of LCGs includes energy information, wherein the energy information is based on the field configuration information in the configuration.

30. A method of wireless communication at a network entity, comprising:
transmitting, for a user equipment (UE), a configuration for a set of buffer status reports (BSRs), wherein the configuration includes field configuration information for each BSR of the set of BSRs associated with a corresponding logical channel group (LCG) in a set of LCGs; and
receiving, from the UE, a BSR for each LCG of the set of LCGs, wherein the BSR for each LCG of the set of LCGs includes energy information, wherein the energy information is based on the field configuration information in the configuration.
